(19) United States
(12) Patent Application Publication
(10) Pub. No.: US 2003/0020952 A1
(43) Pub. Date: Jan. 30, 2003

(54) Order information writing device, order receiving apparatus, portable device, and print order receiving method

(75) Inventor: Takayuki Iida, Kanagawa (JP)

Correspondence Address: SUGHRUE MION, PLLC, 2100 PENNSYLVANIA AVENUE, N.W., WASHINGTON, DC, 20037, US

(73) Assignee: FUJI PHOTO FILM CO., LTD.

(21) Appl. No.: 10/200,441

(22) Filed: Jul. 23, 2002

(30) Foreign Application Priority Data
Jul. 30, 2001 (JP) 2001-229620

(51) Int. Cl. B41J 1/00; G06F 15/00

(52) U.S. Cl. 358/1.15; 358/1.16

(57) ABSTRACT

An object of the present invention is to realize environment in which the user can easily make an order of printing an image of any image content displayed on a display component. When the user seeing the image content displayed on the display component with a writing device designates an image for making an order of printing, image specifying information for specifying the image is written in a scene marker held by the user. When the user makes the order of printing, the image specifying information is read out from the scene marker, and the printing order is received. After confirming the image, a print charge is presented to the user, and reception number is written into the scene marker. Data for printing the image generated by an image order processor is sent to a print finishing operator and subjected to a print finishing process.

### BACKGROUND OF THE INVENTION

1. Field of the Invention

The present invention relates to an order information writing device, an order receiving apparatus, a portable device, and a print order receiving method. Particularly, the invention relates to an order information writing device, an order receiving apparatus, a portable device, and a print order receiving method by which the user makes a printing order.

2. Description of the Related Art

As digitization of image information sources advances, high-quality image content for vividly transferring impressions, such as a digital theater, a digitally broadcasted television program, a live stream on the Internet, and the like are distributed. For example, an electronic signboard is proposed by Japanese Patent Application Laid-Open (JP-A) No. 10-240205 and the like. This electric signboard is disposed in a facility such as a stadium, a theater, a fine arts museum, or another museum, and a scene which is thought will impress the user is photographed in the facility (such as a highlight scene of a sports event, a theatrical performance, or the like) and distributed as image content from the electronic signboard.

Under such circumstances, the user demands for an impressive favorite scene, image and the like to be captured in various image content distributed in various distributing forms and stored as a photographic print. To address the demand, it is necessary to realize an environment, which enables the user (customer) to order printing of any desired image content from the various image content distributed in various distributing forms.

JP-A No. 10-171027 proposes technique related to the above, in which the user designates a frame to be printed in a video program of television broadcast and transmits frame identification information and printing order information to an on-line print finishing operator, and the print finishing operator obtains original image data of the frame to be printed from an image database of a broadcast station, and generates a print.

Presently, an image, which is an object of a printing order, is mainly an image photographed by the user. The user brings a photographic film in which an image as an object of a printing order has been photographed and recorded or a recording medium, in which image data as an object of a printing order is recorded, to a DPE shop. Consequently, it is very easy to specify the image as the image to be included in the printing order.

However, in the case where printing of the image included among any image content can be ordered, there is a problem in that an operation specifying the image as an image that is being printing ordered is very complicated. Particularly, it is difficult to realize “a printing order at a place where image content are displayed” as a condition of the technique disclosed in JP-A No. 10-171027. In the case of making the order of printing in a place different from the place where the image content are displayed, due difficulties in specifying an image as the image to be printed cause heavy burden for the user and the place receiving printing order.

To prevent a photographic print generated in accordance with the order of the user from being delivered to another user by mistake, as an order receiving and delivery method, a DPE shop employs a method of giving an exchange slip to the user upon receipt of the order of printing, asking the user to present the exchange slip upon delivery of the photographic print generated according to the order of the user, checking whether the person who is picking up the photographic print is the user who made the order or not by comparing the exchange slip presented by the user with a copy of the exchange slip recorded on a DPE shop bag, and delivering the photographic print.

On the other hand, when printing of the image included among any image content can be ordered, for convenience of the user, it is desirable to provide environment in which the order of printing can be received at various places and, also in consideration of labor-saving on receiving of a printing order, it is preferable to automate receiving of a printing order. However, automating receiving of a printing order based on the existing order receiving and delivering method has problems such that printers for issuing an exchange slip would have to be provided in places where the printing order is received, and maintenance of supplying sheets and the like are necessary.

In the case of automating receiving of a printing order, information such as a name and contact information of the user, which are presently hand-written by a clerk of the DPE shop on the basis of information provided by the user has to be entered by, for example, the user operating a keyboard. It causes another problem such that a burden on the user for making an order of printing increases.

### SUMMARY OF THE INVENTION

The present invention has been achieved in consideration of the facts and an object thereof is to obtain an order information writing device, an order receiving apparatus, a portable device, and a print order receiving method that are able to realize environment in which the user can easily make a printing order with respect to an image of arbitrary image content displayed on a display component.

To achieve the object, a first aspect provides an order information writing device attached to a display component for displaying image content, the order information writing device comprising: an obtaining component for obtaining, when a user designates an image included among image content displayed on the display component as an image to be printed, information for specifying the image to be printed; and a writing component for writing the information obtained by the obtaining component into the storing component that stores information and is disposed in a portable device which is held by the user and includes at least the storing component.

The order information writing device according to the first aspect is attached to the display component for displaying image content. Specific examples of the display component include an electronic signboard, a television, a computer, a portable telephone having a display section capable of displaying an image, and a screening equipment for screening a movie. Specific examples of the image content displayed on the display component are still images or moving images photographed by a professional photographer (or cameraman), a news photographer, an amateur photographer, or an unmanned camera, moving images or still images of a television broadcast or data broadcast, and arbitrary image content, movie and the like including moving images of a live stream distributed via a computer network.

In the first aspect, when the image of image content displayed on the display component is designated by the user as the image to be printed, the obtaining component obtains the information for specifying the image, which is to be printed. The information specifying the image to be printed can include at least one of information specifying the image content, which includes the image to be printed, and information specifying the image to be printed in the image content. More specifically, the former information includes information identifying the content provider or the content distributor of the image content, which includes the image to be printed, information identifying the display component for displaying the image content to be printed such as information identifying a distributor of the image content, which is distributed via a computer network, and information, which indicates a broadcast date, a broadcast time, and a program for television broadcasts or data broadcasts as image content. The latter information includes, more specifically, time information or time code for specifying the image to be printed in a moving image or a movie as the image content. (Time code denotes identification information added to each frame of a moving image. For example, in the moving image photographed by a video camera, an object is photographed at 30 frames per second, and a time code is assigned to each of the 30 frames.) The information for specifying the image to be printed can be obtained from, for example, a display control component for controlling displaying of image content onto the display component.

In the first aspect, the information obtained by the obtaining component is written by the writing component into the storing component of the portable device held by the user and including at least the storing component capable of storing information. Specific examples of the portable device, include a recording medium such as a memory card, an IC card, a portable telephone, a PDA (Personal Digital Assistant), a wearable computer, and a mobile computer. Information can be written into the portable device by, for example, communication. Considering an amount of labor and the like needed connect a communication cable, wireless communication such as Bluetooth is more preferable than wired communication.

As described above, in the first aspect, when the user who watches image content displayed on the display component feels like storing a specific image included in the displayed image content as a photographic print, the user designates the image as the image to be printed, information specifying the image to be printed is written into the portable device by the order information writing device according to the first aspect, which is attached to the display component. Consequently, by reading out the information written in the portable device at the time of receiving the printing order, the image to be printed can be easily specified on the basis of the read information. Thus, it is unnecessary for the user or the print order receiver to specify the image to be printed, and an environment can be realize in which the user can easily make the printing order with respect to the image included among any image content displayed on the display component.

In the first aspect, preferably, the obtaining component also obtains thumbnail image data of the image designated by the user as the image to be printed, and the writing component also writes the thumbnail image data obtained by the obtaining component. To write the thumbnail image data, the storing component of the portable device has to have a relatively large amount of capacity. However, by reading out the thumbnail image data from the portable device and displaying the read data onto the display component such as the display at the time of receiving the order of printing, the user can confirm the image to be printed, so that an erroneous order of printing can be avoided.

Even in the case where the user erroneously designates the image to be printed, receiving of the order of printing based on the erroneous designation can be prevented. Consequently, the order of printing for the image desired by the user can be made with certainty. In the case where the image content displayed on the display component is the moving images, the thumbnail image may be the still image of a single frame or the moving image comprising a plurality of frames of that were still images displayed within a predetermined time period (for example, a few seconds or a few dozens seconds).

A second aspect provides an order receiving apparatus comprising: a reading component including at least a storing component for storing information, the reading component for reading information, which specifies an image to be printed, from a storing component of a portable device when a user having the portable device, into the storing component of which the information for specifying the image to be printed is written by an order information writing device, expresses an intention to make a printing order; and a first receiving component for receiving the printing order by transmitting the information for specifying the image to be printed, which information is read out by the reading component, to an image order processor connected via a communication line, for receiving the printing order from the user and performing a predetermined process, wherein the order information writing device is attached to a display component for displaying image content, the order information writing device comprises: an obtaining component for obtaining, when the user designates an image included among image content displayed on the display component as an image to be printed, information for specifying the image to be printed; and a writing component for writing the information obtained by the obtaining component into the storing component that stores information and is disposed in a portable device held by the user and includes the at least the storing component.

In the second aspect, at least the storing component capable of storing information is provided. When the user, who has the portable device in the storing component of which the information specifying the image to be printed is written by the order information writing device of the first aspect, expresses an intention to make the order of printing, the information specifying the image to be printed is read out from the storing component of the portable device by the reading component. The first receiving component receives the order of printing by transmitting the information specifying the image to be printed, which is read out by the reading component, to the image order processor connected via a communication line, to receive the order of printing from the user and perform the predetermined process (for example, a process for generating the photographic print of the image to be printed and a process associated with the generation of the print, a process of making an order to a print finishing operator and a process associated with the ordering, calculation of a fee for the order of printing, and the like).

Therefore, the user who feels like storing the specific image included in the image content displayed on the display component as the photographic print designates the image to be printed to the order information writing device of the first aspect, thereby writing the information specifying the image to be printed into the portable device. Afterwards, the user expresses the intention to make the order of printing to the order receiving apparatus according to the second aspect, thereby enabling the order of printing to be made. Thus, the environment in which the user can easily make the order of printing for the image of any contents displayed on the display component can be realized.

The communication line of the invention may be a public communication line (or a network such as the Internet, which includes the public communication line). However, when the communication line is a dedicated communication line (or a network comprising dedicated communication lines), a large amount of data can be easily transferred stably in short time. Since leakage of data and the like does not easily occur, security is high. It is difficult for the dedicated communication line to be damaged by a computer virus and the like, thus, the dedicated communication line is more preferable.

In the second aspect, the first receiving component preferably performs at least one of reading information specifying the user, which is written in the storing component of the portable device in advance and transmitting the information to the image order processor and an operation of writing information for identifying the received order of printing into the storing component of the portable device.

When the information specifying the user is written in the storing component of the portable device in advance, and this information is read out and transmitted to the image order processor, at the side generating the photographic print, the information received by the image order processor is attached to the generated photographic print, and the attached information is collated with the information specifying the user, which information written in the storing component of the portable device held by the user who is receiving the photographic print, thereby enabling the identity of the user to be authenticated.

Also in the case of writing the information for identifying the received order of printing into the portable device, at the side generating the photographic print, the information for identifying the order of printing is attached to the generated photographic print, and the attached information is collated with the information identifying the order of printing, which information is written in the storing component of the portable device held by the user who is receiving the photographic print, thereby enabling the identity of the user to be authenticated.

In such a manner, it becomes unnecessary to use an order receiving and delivering method of issuing an exchange slip or the like upon receipt of the order of printing and giving the exchange slip to the user and checking the exchange slip at the time of delivery of the photographic print. Consequently, maintenance of supplying sheets of paper for a printer provided to issue exchange slips or the like also becomes unnecessary, so that labor for the reception of the order of printing can be reduced.

In the second aspect, it is preferable to further provide a confirming component for confirming the expressed intention of making the order of printing the image whose thumbnail image is displayed on the display component. For example, when the user expresses the intention of making the order of printing, by displaying the thumbnail image of the image to be printed on the display component (such as an LCD or CRT) capable of displaying any information. With this configuration, the user can reconfirm the image to be printed on reception of the order of printing, so that the erroneous order of printing can be avoided.

The thumbnail image of the image to be printed can be displayed on the display component by, for example, in the case where the thumbnail image data written by the writing component in the first aspect is stored in the storing component of the portable device, using the thumbnail image data read out from the storing component of the portable device by the reading component. The thumbnail image data of the image to be printed can be obtained also by requesting the image content distributor or the image content provider directly or indirectly via the image order processor or the like to transfer the thumbnail image data of the image to be printed, based on the information specifying the image to be printed, which information is read out from the storing component of the portable device by the reading component and receiving the thumbnail image data via a communication line or the like.

A third aspect provides an order receiving apparatus attached to a display component for displaying image content, the order receiving apparatus comprising: an obtaining component, for obtaining information specifying an image which is to be printed when a user designates an image included among image content displayed on the display component as the image to be printed; and a second receiving component for receiving a printing order by transmitting the obtained information specifying the image to be printed to an image order processor, which is connected via a communication line receives the order of printing from the user, and performs a predetermined process performing at least one of an operation of reading information specifying the user written in a storing component of a portable device in advance, which portable device is held by the user and is provided with at least the storing component capable of storing information, and transmitting the read information to the image order processor, and an operation of writing information identifying the received printing order into the storing component of the portable device.

The order receiving apparatus according to the third aspect is attached to the display component for displaying image content. When the user designates the image included among the image content displayed on the display component as the image to be printed, in annoyer similar to the first aspect, information specifying the image to be printed is obtained by the obtaining component. The information for specifying the image, which is ordered to be printed, can be obtained from, for example, a display control component for controlling display of the image content to the display component. The information specifying the image to be printed, which information is obtained by the obtaining component is transmitted to the image order processor, which is connected via a communication line. The image order processor receives the order of printing from the user, and performs the predetermined process, thereby receiving the order of printing in a manner similar to the second aspect.

Therefore, the user who feels like storing the specific image included in the image content displayed on the display component as the photographic print designates the image to be printed to the order information writing device of the third aspect, thereby enabling the order of printing to be made. Thus, the environment in which the user can easily make the order of printing for the image contents displayed on the display component, can be realized.

The second receiving component performs at least one of: reading the information for specifying the user written in a storing component of a portable device in advance which portable device is held by the user and includes at least the storing component capable of storing information and transmitting the read information to the image order processor; and writing information for identifying the order of printing received into the storing component of the portable device. In a manner similar to that of the second aspect, it becomes unnecessary to use the order receiving and delivering method of issuing an exchange slip or the like, the giving the exchange slip to the user on receipt of the order of printing and checking the exchange slip at the time of delivery of the photographic print. Consequently, work for the reception of the order of printing can be saved.

Considering that the details of the order of printing (for example, the number of prints, print size, and the like) vary according to the users, in the second and third aspects, preferably, the first or second receiving component transmits information, which indicates the details of the order of printing designated by the user, to the image order processor. Consequently, a photographic print can be generated according to the details of the order desired by each user.

The details of the order of printing designated by the user include at least one of, for example, the number of prints, a print size, the kind of recording material that records the image (for example, glossy or matte finish), a designation of a processing for the image to be printed (for example, enlargement/reduction of the image, color correction, or the like) and synthesis of the image to be printed (for example, synthesis of the image with characters, a template for a new year's card or a template for a calendar).

In the case where a user makes the printing order for the image included among any image content which image content is other than images photographed by the user, there is a possibility that the user has to pay not only the fee for generating the photographic print but also compensation to another person (examples include the content provider, the content distributor, a copyright holder, and a holder of the rights to one's portrait) for using the image. The possibility that the cost varies according to the kind of the image content and the like is high. Consequently, in the second or third aspect, the predetermined process performed by the image order processor includes a process of calculating a fee for the order of printing made by the user and notifying the user of the fee, and the first or second receiving component preferably allows the fee notified from the image order processor to be displayed on the display component capable of displaying any information. Thus, the user can recognize the fee of the order of printing at the time of making the order of printing.

In the second or third aspect, it is preferable to further provide a payment process component for performing a process for paying for the order of printing in co-operator with a payment information holding component which is mounted on the portable device held by the user, for holding information for making the payment for the order of printing made by the user.

The method of paying the order of printing may be prepaid or by a credit card. In the case where the payment method is the prepaid method, as a process for paying the order of printing, for example, under a condition that the user pays the compensation in advance, a process of updating the rates as information for payment of the order of printing, which rates are held in the payment information holding component in accordance with the order of printing made by the user, can be performed. In the case where the payment method is the credit card, as the process of paying the order of printing, a process of obtaining the number of the credit card of the user as information for payment of the order of printing is held in the payment information holding component and requesting a third party to perform authentication of the user and payment on the basis of the obtained number of the credit card can be executed. Consequently, the payment of the order of printing can be completed upon receipt of the order of printing so that the user does not have to carry cash or the like for paying the order of printing.

In the second or third aspect, an input component for inputting desired information by the user is provided and the input of at least one (and preferably, all) of the expression by the user of the intention to make the order of printing, the designation of the image to be printed, the instruction of the details of the order of printing, and the information for making the payment for the order of printing can be performed via the input component. If the portable device held by the user is the portable telephone, the PDA, the wearable computer, the mobile computer, or the like, the input component such as a numeric keypad or a keyboard is provided. Therefore, the expression by the user of the intention to make the order of printing, the designation of an image to be printed, the instruction of the details of the order of printing, and the input of information for making a payment for the order of printing may be performed via the input component provided on the portable device side.

A fourth aspect provides a portable device for operation by a user and including at least a storing component for storing information, the portable device comprising:

a storing component for having information specifying an image to be printed written by a writing component of an order information writing device when the user designates, to the order information writing device, the image included among image content displayed on a display component as the image to be printed and, for having the information specifying the image to be printed be read out therefrom by a reading component of an order receiving apparatus when the user expresses, to the order receiving apparatus, an intention to make the order of printing,

wherein the order information writing device is attached to the display component for displaying the image content, and the order information writing device includes an obtaining component for obtaining, when the user designates an image included among image content displayed on the display component as an image to be printed, information for specifying the image to be printed; and a writing component for writing the information obtained by the obtaining component into the storing component that stores information and is disposed in the portable device which is held by the user and includes at least the storing component, and the order receiving apparatus includes a reading component including at least a storing component for storing information, the reading component for reading information, which specifies an image to be printed, from a storing component of a portable device when the user having the portable device, into the storing component of which the information for specifying the image to be printed is written by an order information writing device, expresses an intention to make a printing order; and a first receiving component for receiving the printing order by transmitting the information for specifying the image to be printed, which information is read out by the reading component, to the image order processor for receiving the printing order from the user and performing a predetermined process, the image order processor being connected via a communication line.

According to the fourth aspect, when the user designates the image to be printed to the order information writing device of the first aspect, the information for specifying the image to be printed is written into the storing component of the portable device by the writing component of the order information writing device, so that the information for specifying the image to be printed is carried by the portable device. When the user expresses the intention to make the order of printing to the order receiving apparatus of the second or third aspect, the information which information is specifying the image to be printed, carried on the portable device, is read out by the order receiving apparatus.

Consequently, in annoyer similar to the first and second aspects, it becomes unnecessary for the user or the print order receiver to specify the image to be printed. Thus, the environment in which the user having the portable device can easily make the order of printing for the image included among desired image content displayed on the display component can be realized.

In the fourth aspect, the user expresses the intention to make the order of printing, thereby performing, with the first receiving component of the order receiving apparatus, at least one of reading the information specifying the user written in the storing component in advance and writing the information identifying the order of printing received by the first receiving component into the storing component. According to the aspect, in a manner similar to the second aspect, labor for receiving the order of printing can be saved.

A fifth aspect comprises a portable device held by a user and comprising at least a storing component capable of storing information, wherein the portable device performs, with a second receiving component of an order receiving apparatus, at least one of an operation of storing information for specifying the user and reading the information for specifying the user which is written in the storing component in advance, when the user designates, to the order receiving apparatus of the third aspect an image of image content displayed on a display component as an image to be printed and expresses an intention to perform a printing order and an operation of writing the information for identifying the order of printing received by the second receiving component, into the storing component.

According to the fifth aspect, when the user expresses the intention to make the order of printing by designating the image to be printed to the order receiving apparatus of the third aspect, at least one of reading the information specifying the user written in the storing component in advance and writing the information identifying the order of printing received by the second receiving component into the storing component is performed by the second receiving component of the order receiving apparatus. Consequently, in a manner similar to the third aspect, it becomes unnecessary to use the order-receiving and delivering method, which issues the exchange slip or the like, gives the exchange slip to the user upon receipt of the order of printing and checks the exchange slip at the time of delivery of the photographic print. Consequently, labor for the reception of the order of printing can be saved.

In the fourth or fifth aspect, a payment information holding component for holding information for making a payment of the order of printing made by the user and performing, in co-operation with a payment process component, a process of making a payment for the order of printing may be further provided. With the configuration, in a manner similar to the third aspect, the payment of the order of printing can be completed on receipt of the order of printing, without the user having to carry the cash or the like to pay the order of printing.

A sixth aspect provides a print order receiving method comprising the steps of: obtaining information for specifying an image to be printed when a user designates an image included among image content displayed on a display component as an image to be printed; writing the obtained information into a storing component of a portable device, which is held by the user and provided with at least the storing component capable of storing information; reading the information for specifying the image to be printed when the user expresses intention to make an order of printing, which information is written in the storing component of the portable device held by the user; and receiving the order of printing by transmitting the read information for specifying the image to be printed to an image order processor for receiving the order of printing from the user and performing a predetermined process.

A seventh aspect provides a print order receiving method comprising the steps of:

obtaining information for specifying an image to be printed when an image included among image content displayed on a display component is designated by the user, as an image to be printed;

receiving the order of printing by transmitting the information for specifying the obtained image to be printed to an image order processor which receives the order of printing from the user and performs a predetermined process; and performing at least one reading of the information for specifying the user written, in advance, in a storing component of a portable device held by the user and provided with at least the storing component capable of storing information and writing of the received information for identifying the received order of printing.

Consequently, in a manner similar to the third aspect, the environment in which the user can easily make an order of printing an image of arbitrary image content displayed on the display component can be realized and work of receiving the order of printing can be also saved.

As described above, in the first aspect, the order information writing device is attached to the display component. When the user designates the image included among image content displayed on the display component as the image to be printed, information specifying the image to be printed is obtained and written into the storing component of the portable device, which is held by the user and includes the storing component capable of storing information. There is consequently an excellent effect, in that the environment in which the user can easily make the order of printing with respect to the image included among any image content displayed on the display component can be realized.

In the first aspect, it is also possible to obtain the thumbnail image data of the image designated by the user as the image to be printed, and write the thumbnail image data into the storing component of the portable device. With this configuration, in addition to the aforementioned effect, another effect, which allows erroneous order of printing to be avoided, is produced.

In the second aspect, when the user, who possesses a portable device in which information for specifying the image to be printed is written by the order information writing device, expresses the intention to make the order of printing, the information for specifying the image to be printed is read out and transmitted to the image order processor, and the image order processor receives the order of printing. Thus, there is the excellent effect that the environment in which the user can easily make the order of printing for the image included among any image content displayed on the display component can be realized.

In the second aspect, at least one of: reading the information specifying the user, which information is written in the portable device in advance, and transmitting the information to the image order processor; and writing the information identifying the received order of printing into the storing component of the portable device may be performed. Thus, in addition to the above effect, an effect is produced such that labor for reception of the order of printing can be saved.

In the second aspect, when, by displaying the thumbnail image of the image to be printed on the display component, the user expresses the intent to make the order of printing, the expressed intention of making the order of printing can be confirmed. With this configuration, in addition to the above effect, an effect is produced such that the erroneous order of printing can be avoided.

According to the third aspect, when the image among the image content displayed on the display component is designated as the image to be printed, information specifying the image to be printed is obtained and transmitted to the image order processor. The image order processor thereby receives the order of printing, and at least one of: reading the information for specifying the user written in a portable device in advance, which portable device is held by the user, and transmitting the read information; and writing information for identifying the order of printing received by the portable device, is performed. Thus, excellent effects are obtained such that the environment in which the user can easily make the order of printing for the image included among any image content displayed on the display component can be realized, and labor for receiving the order of printing can be saved.

In the second or third aspect, information expressing the designated details of the order of printing may be transmitted to the image order processor. Consequently, in addition to the above effects, an effect is produced such that the photographic print can be generated in accordance with the details of the order desired by the users.

In the second or third aspect, the fee for the order of printing made by the user, which fee the image order processor calculates and notifies the user may be displayed on the display component. With the configuration, in addition to the above effects, an effect is produced such that the user can recognize the fee for the order of printing on placement thereof.

In the second or third aspect, the process for paying the order of printing may be performed in co-operation with the payment information holding component, which is mounted on the portable device held by the user, for holding information for the user to pay the order of printing. Thus, in addition to the above effects, the effect is produced such that the payment of the order of printing can be completed on reception of the order of printing so that it becomes unnecessary for the user to bring the cash or the like to pay the order of printing.

The fourth aspect provides the portable device held by the user. Information specifying the image to be printed is written by the writing component of the order information writing device when the user designates the image included among the image content displayed on the display component as the image to be printed. The information specifying the image to be printed is read out by the reading component of the order receiving apparatus when the user expresses the intention to make the order of printing. Thus, the excellent effect is produced such that the environment, in which the user having the portable device can easily make the order of printing for the image included among any image content displayed on the display component, can be realized.

In the fourth aspect, the user expresses the intention to make the order of printing, thereby performing, with the first receiving component of the order receiving apparatus, at least one of: reading the information specifying the user written in advance; and writing the information identifying the order of printing received by the first receiving component. According to the aspect, in addition to the above effect, the effect is produced such that the labor for receiving the order of printing can be saved.

According to a fifth aspect, there is provided the portable device held by the user, in which the information specifying the user is stored and when the user expresses the intention to make the order of printing by designating the image included among the image content displayed on the display component as the image to be printed, at least one of: reading the information specifying the user written in advance; and writing the information identifying the order for printing received by the second receiving component is performed by the second receiving component of the order receiving apparatus. Thus, in addition to the above effect, the effect is produced such that the labor for receiving the order of printing can be saved.

In the fourth or fifth aspect, information for making the payment for the order of printing made by the user is held and the process for paying for the order of printing in co-operation with the payment process component may be performed. With this configuration, in addition to the above effects, there is also an effect such that the payment of the order of printing can be completed on receipt of the order of printing, so that it is unnecessary for the user to carry the cash or the like to pay the order of printing.

According to a sixth aspect, when the image included among image content displayed on the display component is designated as the image to be printed, information specifying the image to be printed is obtained and written into the storing component of the portable device held by the user. When the user expresses the intent to make the order of printing, the information specifying the image to be printed, which information is written in the storing component of the portable device, is readout and transmitted to the image order processor. Thus, the image order processor receives the order of printing. Thus, the excellent effect is produced such that the environment in which the user can easily make the order of printing for the image included among any image content displayed on the display component can be realized.

According to the seventh aspect, when the image displayed on the display component is designated as the image to be printed, the information specifying the image to be printed is obtained and transmitted to the image order processor for receiving the order of printing from the user and performing the predetermined process, thereby receiving the order of printing. In addition, at least one of: reading the information specifying the user written in the portable device held by the user in advance; and writing the received information identifying the received order of printing is also performed. Consequently, the excellent effects are produced such that the environment in which the user can easily make the order of printing for the image included among any image content displayed on the display component can be realized and the labor for receiving the order of printing can be also saved.

### BRIEF DESCRIPTION OF THE DRAWINGS

FIG. 1 is a block diagram showing an example of a schematic configuration of an image-distributing and order-processing system according to this embodiment.

FIG. 2A is a block diagram showing an example of a schematic configuration of a card-type scene marker.

FIG. 2B is a block diagram showing an example of a schematic configuration of a scene marker provided in a portable telephone.

FIG. 3A is a block diagram showing a schematic configuration of a writing device.

FIG. 3B are timing charts showing an example of writing of image specifying information in the writing device.

FIG. 4 is a sequence diagram showing an example of a sequence of ordering printing of image content displayed on a display component with a write component.

FIG. 5 is a sequence diagram showing another example of a sequence of ordering printing of image content displayed on the display component with the write component.

FIG. 6 is a sequence diagram showing an example of a sequence of ordering printing of image content displayed on a portable telephone which can function as a display component with a receiving machine or as a receiving machine.

FIGS. 7A to 7C are flowcharts showing the details of an image order receiving and distributing process executed by an image order processing apparatus.

FIGS. 8A to 8D show images of a case of making an order of printing best-shot images of a sports event displayed on electronic signboards.

FIGS. 9A to 9D show images of a case of making an order of printing a scene the user likes in a movie screened in a movie theater.

### DESCRIPTION OF THE PREFERRED EMBODIMENTS

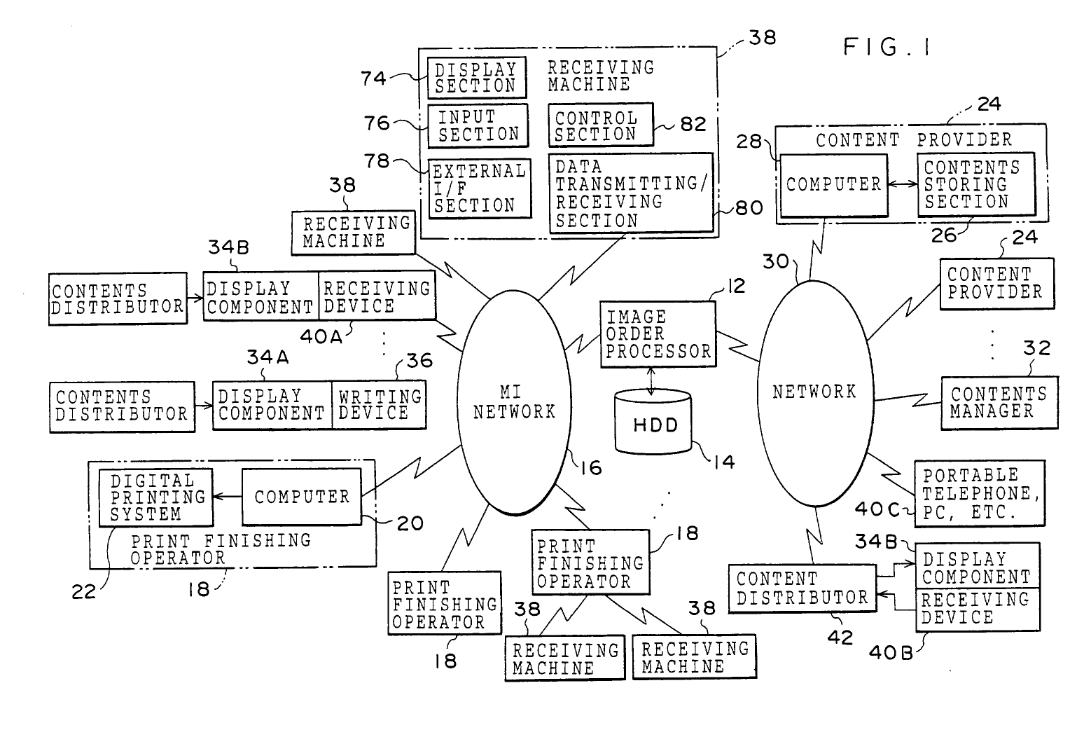

An example of an embodiment of the present invention will be described hereinbelow with reference to the drawings. FIG. 1 shows an image distributing and order-processing system 10 according to the embodiment. The image distributing and order-processing system 10 realizes an environment in which various image content are distributed to the user via various distribution components and the user can order printing of an image of desired image content. In the following, first, a part of processing an order of printing from the user (print order processing system) in the image distributing and order-processing system 10 will be described.

Print Order Processing System

The image distributing and order-processing system 10 has an image order processor 12 disposed in a large-scale photo lab (so-called large photo lab) or the like existing in each of core cities in the country. The image order processor 12 takes the form of a computer such as a workstation in which, although not shown, a CPU, a ROM, a RAM, and an input/output port are connected to each other via a bus, and a display such as a CRT or LCD, a mouse, a keyboard, a hard disk drive (HDD) 14 (refer to FIG. 1),a CD-ROM drive, a communication controller (for example, a modem or a router), and the like are connected to input/output ports. By executing a predetermined program by the CPU of the computer, the image order processor 12 functions as an image order receiving apparatus in a second embodiment.

(A communication controller of) the image order processor 12 is connected to an MI network 16 configured by high-speed and large-capacity dedicated communication lines. Computers 20 (for example, personal computers (PC)) owned by a number of print finishing operators 18 existing in the country are connected to the MI network 16. In place of the MI network, a computer network such as the Internet may be used.

The print finishing operator 18 has a digital printing system 22 including devices such as a film scanner for scanning images recorded on a photographic film and a digital printer for performing a printing finishing process for recording an image of image data onto a recording material such as photographic paper. The digital printing system 22 is connected to the computer 20, and can perform a printing finishing process by using image data received by the computer 20 via the MI network.

Image Contents Distribution

Distribution of image content to the user will now be described. In the embodiment, content providers for providing image content include, for example, providers exclusively providing contents such as a program creator for creating a program (video image or still image (still image can be distributed by using data broadcast of, for example, BS digital broadcast), a distributing company for distributing a movie screen in a digital theater, and a video creator for creating a live image distributed by an Internet live site. Other than the above, a professional photographer, an amateur photographer, an astronomical observatory, an aerial photograph company, owners of unmanned fixed-point cameras and, moreover, by using personal casting service “PercasTV” which has started recently or the like, anyone can be content providers.

Examples of image content provided by the content providers are various images and still images aired in a digital broadcast, a movie screen in a digital theater, various live video images distributed from Internet live sites, various photographs taken by professional and amateur cameramen (for example, photographs of impressive scenes such as a highlight scene from a sports event, photographs of a live show, photographs of art museums and other museums, scoop photograph, photographs of various scenes (for example, athletic meeting, concert, school excursion, regular classes, graduation ceremony, entrance ceremony, coming-of-age day, and festival) taken by a local photographers, space photograph taken by an astronomical observatory, aerial photograph taken by an aerial photograph company, a fixed point observation photograph taken by an unmanned fixed-point camera, and a fixed-point commemorative photograph taken in a famous sightseeing area. An image of a TV game and a medical image (such as an X-ray photograph) may be also included.

The image content is distributed as follows. A program (video image and still image) created by a program creator is brought in a broadcast station (content distributor) of a digital broadcast and distributed (broadcast) by the broadcast station. The image content broadcast by the broadcast station are displayed on a display (display component) of an electronic device (such as a TV or PC) having the function of receiving the digital broadcast to present the same to the user. A movie distributed by a distribution company is brought in a digital theater (content distributor) and distributed (screened) by a screening system of the digital theater to be thereby presented to the user who came to the digital theater. In the embodiment, the screening system corresponds to the display component.

A live video to be distributed to an Internet live site created by a video creator is transmitted to the administrator (content distributor) of the Internet live site, and distributed onto the Internet by the administrator. When the user accesses the live site via an information terminal (PC, portable telephone, portable information device, or the like) having the function of connection to the Internet, the live video distributed by the administrator of the Internet live site is displayed on a display (display component) of the information terminal and is thereby presented to the user.

Other distribution components for distributing the image content are an electronic signboard and the Internet. The electronic signboard is constructed by including a display and a communication control unit which is connected to a communication line and receives data of an image to be displayed on the display and is disposed in, for example, well-trafficked locations, a facility where the possibility that the user comes across an impressive sight, and the like. The image content provided by the administrator of the electronic signboard from the content provider are displayed and distributed on the electronic signboard (display component) by the administrator of the electronic signboard (content distributor) to be distributed, and presented to the user who comes across the electronic signboard mounting location.

Distribution of image content by using the Internet as the distribution component is carried out when the content provider brings the image content into the administrator (content distributor) of a Web site (for example, an Internet live site) for distributing the image content or the content provider discloses (distributes) the image content on a Web site operated by the content provider itself (in this case, the content provider itself also serves as the content distributor). Presentation of the image content to the user in the embodiment is realized when the user accesses a Web site which distributes image content via an information terminal (PC, portable telephone, portable information device, or the like) having the function of making connection to the Internet, and image content distributed by the Web site accessed are displayed on the displayed (display component) of the information terminal.

Management of Image Content

In the image distributing and order-processing system 10, image content distributed by the content distributor to the user are managed (stored) so as to correspond to a printing order by the user. Specifically, as shown by reference numeral 24 in FIG. 1, the content provider has a contents storing unit 26 for storing data of an image (high-resolution high-quality image data, data of a low-resolution thumbnail image, and charge information) included in image content provided from a storing component such as HDD to the content distributor. The charge information indicates an image fee made when high-quality image data is used for generating a photographic print. The image fee is paid to the content provider as a copyright holder. In the case of an image in which a predetermined person is an object, a part of the image charge may be paid as the rights to his/her portrait to the subject person as the object.

The content storing unit 26 is connected to a computer 28, and the computer 28 is connected to a network 30. The image order processor 12 is also connected to the network 30, and the computer 28 can communicate with the image order processor 12 via the network 30.

The network 30 may be a public telephone network, a dedicated communications network, a portable telephone network in which a number of exchanges are connected to each other via a communication line and a number of base stations controlling wireless communications with a portable telephone disposed in different places are connected to any of a number of exchanges, or a computer network (such as Internet) in which a number of web servers such as work stations are connected to each other via communication lines, or may include a part or all of the various networks.

The invention is not limited to the case where image content distributed to the user is managed (stored) by the content provider. The image content distributed to the user may also be managed by a contents manager (indicated by reference numeral “32” in FIG. 1) under a commission from the content provider, or may be managed by the content distributor.

User Printing Order Method

In the image distributing and order-processing system 10, as ordering methods of making an order of printing an image of desired image content by the user, some methods exist. A typical ordering method is an ordering method (first ordering method corresponding to a print order receiving method in a sixth embodiment) using a writing device (corresponding to an order information writing device in a first embodiment)provided in or attached to a display component, a scene marker (corresponding to a portable device in a fourth embodiment) owned by the user, and a receiving machine (corresponding to an order receiving machine in a second embodiment). In the first ordering method, an image ordering component according to the invention includes the writing device, scene marker, and receiving machine. First, the scene marker will be described hereinbelow.

The scene marker is a tool capable of writing information for specifying an image (image as an object of a printing order) (image specifying information) by the writing device in response to an instruction when there is an image the user desires to store as a photograph print in various image content distributed to the user. When the user makes a printing order via the receiving machine (which will be described hereinafter), image specifying information written in the scene marker owned by the user is read out by the receiving machine and transmitted to the image order processor 12. With the arrangement, without requiring the user to do a complicated work of, for example, telling an image as an object of printing order at the time of making a print order, it enables an image as an object of printing order to be specified by the image order processor 12.

The scene marker has, desirably, a card shape so that the user can have and carry the scene marker easily. The simplest configuration of the scene marker is a magnetic card. However, the existing magnetic card has drawbacks such that an amount of storable information is limited (only data of about 72 characters can be stored), the card is easily counterfeited, and a malicious third party can illegally read out data from the card.

Consequently, also considering that not only image specifying information but also other information (for example, personal information of the user which the user has to give at the time of making a printing order) is written in the scene marker, it is desirable that the scene marker be constructed by an IC card. Since an existing IC card has a large-capacity storing component capable of storing thousands of characters and also a CPU and a program can be stored in the IC card, by stringently protecting the card with a key for reading information in a chip, illegal reading of data by a malicious third party can be prevented. It is substantially impossible to counterfeit the IC card, so that the IC card is suitable for the scene marker.

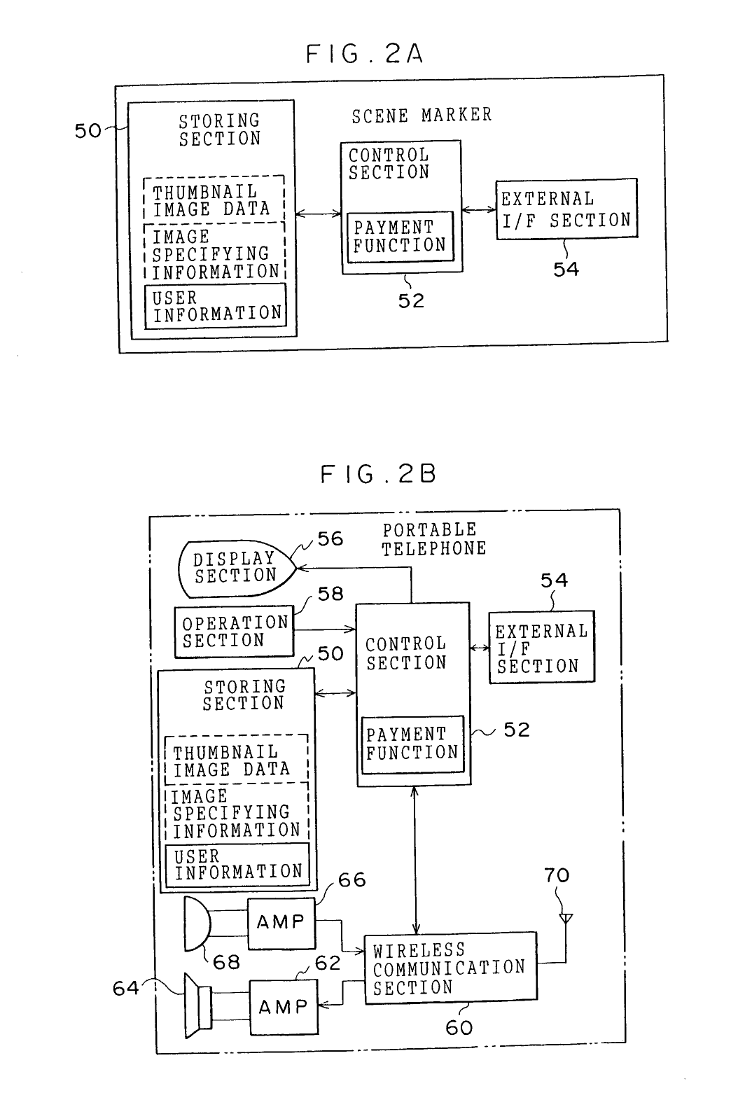

FIG. 2A shows an example of the configuration of a card-type scene marker constructed by an IC card. The scene marker is constructed to include a storing unit 50 capable of storing arbitrary information including image specifying information, a control unit 52 constructed by including a CPU, and an external I/F section 54 for transmitting/receiving information to/from the outside.

Interfaces between an IC card and the outside are roughly divided into a contact type and a non-contact type. The non-contact type interfaces include a close range type of which maximum communicable range is about 2 mm, a short range type of which maximum communicable range is about 10 cm, a neighborhood type of which maximum communicable range is about 70 cm, and a microwave type of which maximum communicable range is a few meters (communicable even the user moves; a standard such as Bluetooth and HomeRF can be employed). The external I/F section for a scene marker can employ any of the types. It is preferable to employ a non-contact type of which communicable distance is relatively long since the user does not have to perform an operation of taking out a card-type scene marker and setting it in a predetermined position of the receiving machine at the time of making printing order.

In the storing unit 50, personal information of the user (user information) of the scene marker is preliminarily stored. The user information can include at least one of the user ID for identifying the user, name of the user, address of the user, and a contact of the user (any of telephone number, facsimile number, and E-mail address). The user information stored in the storing unit 50 is read out from the storing unit 50 of the scene marker by the receiving machine when the user makes an order of printing via the receiving machine and transmitted to the image order processor 12.

As shown in FIG. 2A, the control unit 50 has preferably a settlement function. A settlement method may be a prepaid type or a credit type. By the function, at the time of a printing order made by the user, payment can be also completed via the receiving machine. Authentication of identification of an individual and settlement can be also performed by using services provided by a third party institute.

The scene marker is not limited to the card type. The function of the scene marker may be provided in a portable telephone, or a portable information device such as a portable telephone having the function to be connected to a PDA (Personal Digital Assistant), a wearable computer, a mobile computer, and a computer network such as the Internet. FIG. 2B shows an example of the configuration of the scene marker provided in a portable telephone.

The scene marker includes the storing unit 50, control unit 52, and external I/F section 54. To the control unit 52, a display unit 56 taking the form of an LCD or the like, capable of displaying various information including an image, an operation unit 58 constructed by including a power switch and a numeric keypad, and a wireless communication unit 60 are connected. To the wireless communication unit 60, a speaker 64 is connected via an amplifier 62, a microphone 68 is connected via an amplifier 66 and, further, an antenna 70 is connected. The wireless communication unit 60 has the function of performing wireless communication with a base station connected to a wired public telephone line by electromagnetic waves in a predetermined frequency band for a portable telephone. At present, a portable telephone is widely spread. The portable telephone is made to have the function of the scene marker, thereby preventing the user from feeling inconvenienced by carrying the scene marker as compared with a scene marker having the single function.

The scene marker can be distributed in such manners that parties concerned such as a content distributor, a large photo lab, and a print finishing operator distribute scene markers to the users at no charge. In an embodiment of making a portable telephone or a portable information device function as a scene marker, by distributing a program for making the portable telephone or portable information device function as a scene marker (by distributing recording media each storing the program at no charge or enabling the program to be downloaded at no charge).

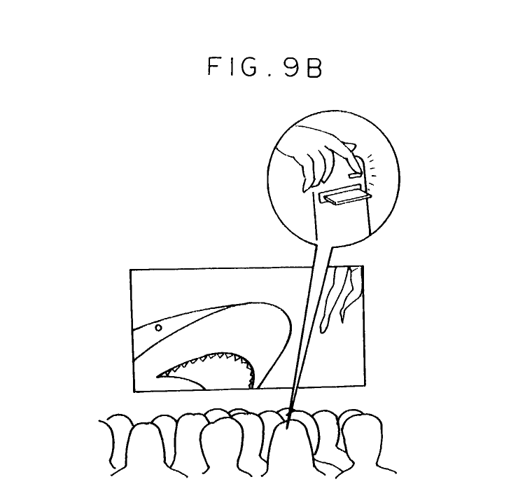

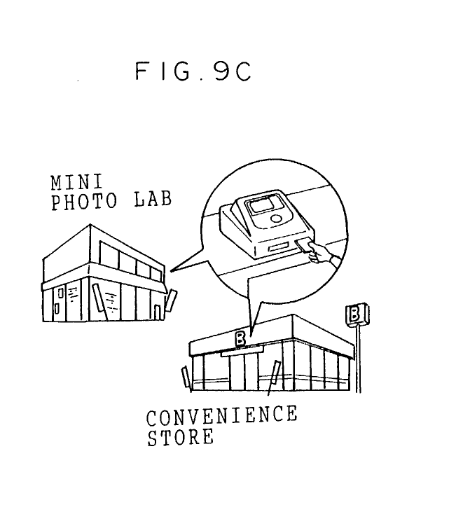

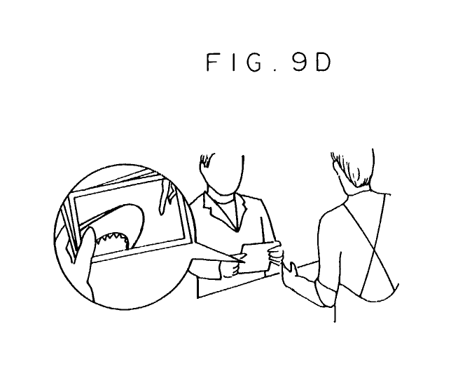

The writing device will now be described. Writing of the image specifying information to the scene marker is performed by a writing device 36 provided in or attached to a display component 34A as shown in FIG. 1. As the display component 34A, any display component (television, PC, portable telephone, portable information device, electronic signboard, screening facility of a digital theater, and the like) can be applied. For example, in the case where the display component 34 is a screening facility of a digital theater, the writing device 36 can be provided for a seat on which the user sits (refer to FIG. 9A as an example).

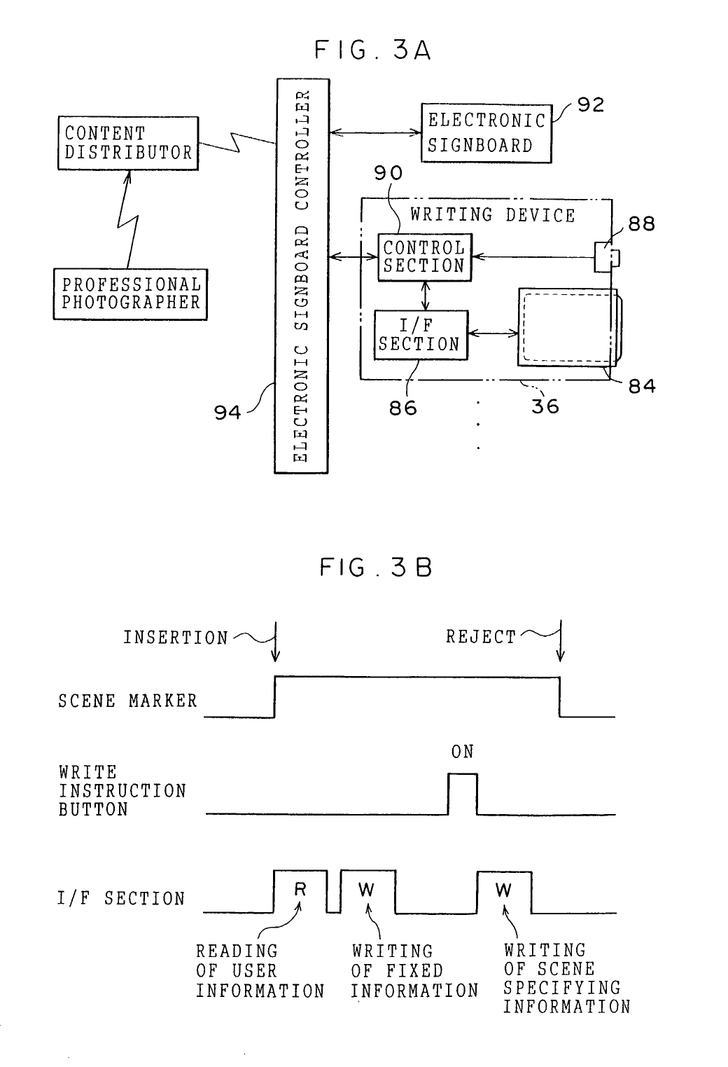

Taking the writing device 36 attached to the electronic signboard as an example, the configuration of the standard writing device 36 on the condition that the scene marker is of a card type will be described. As shown in FIG. 3A, the writing device 36 is constructed by including a loading unit 84 for loading the scene marker, an I/F section 86 for transmitting/receiving information to/from the scene marker loaded in the loading unit 84, an input unit 88 provided with a write instruction button for instructing writing of the image specifying information by the user and the like, and a control unit 90 in which a CPU, a ROM, a RAM, input/output ports, and the like are connected to each other and which is connected to the I/F section 86 and the input unit 88. The control unit 90 is connected to a display control component (in this example, an electronic signboard controller 94 for controlling display of image content onto a display component (in this example, an electronic signboard 92).

The configuration shown in FIG. 3A relates to the case where the interface between the scene marker and the outside is of the contact type or the non-contact type whose communicable distance is relatively short. If the interface between the scene marker and the outside is of the non-contact type whose communicable distance is relatively long, the I/F section of the write device 36 can be constructed by a wireless communication unit for performing wireless communication with the scene marker. If the scene marker is provided in a portable telephone, the input unit 88 can be replaced by the operation unit 58 of the portable telephone.

As an example, as shown in FIG. 3B, when the scene marker is loaded in the loading unit 84, the control unit 90 of the writing device 36 attached to the electronic signboard reads the user information and the like stored in the storing unit 50 in the scene marker via the I/F section 86, confirms that the loaded card is a scene marker, obtains fixed information which is fixed irrespective of an image as an object of a printing order in image specifying information to be written into the scene marker (alternately, it is also possible to provide a storing unit for preliminarily storing fixed information and read out the information, thereby obtaining the fixed information or to obtain the fixed information from the electronic signboard controller 95), and writes the obtained fixed information into the storing unit 50. When the input unit 88 is operated by the user (for example, a write instruction button is turned on) to instruct writing of image specifying information of an image as an object of a printing order, information (scene specifying information) other than the fixed information out of the image specifying information is obtained from the electronic signboard controller 94 (corresponding to the display control component described in the first embodiment) and written into the storing unit 50.

The fixed information may be written simultaneously with the scene specifying information. Among the above-described processes, a process of obtaining the image specifying information corresponds to an obtaining component in the first embodiment. The process of writing the obtained information specifying information into the storing unit 50 of the scene marker corresponds to the writing component in the first embodiment.

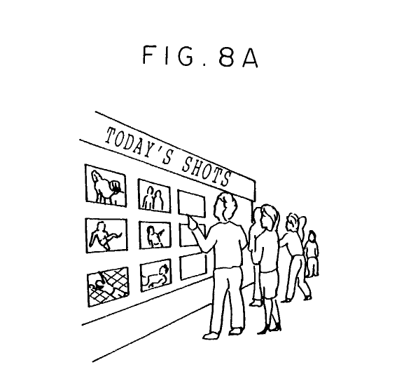

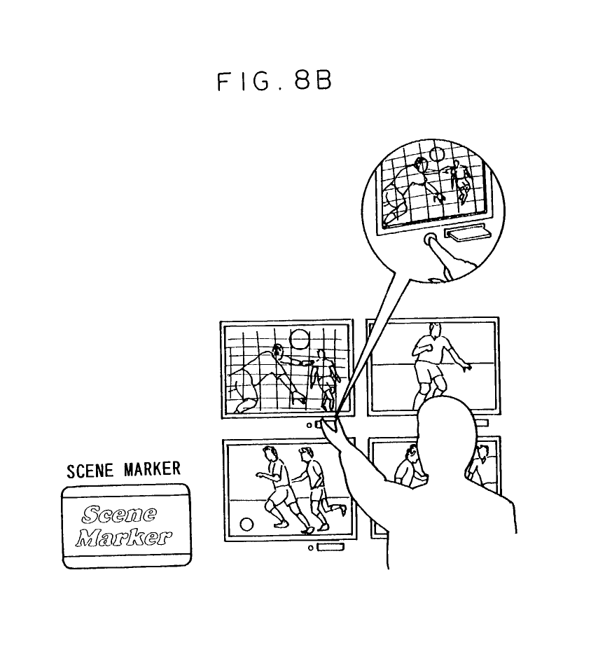

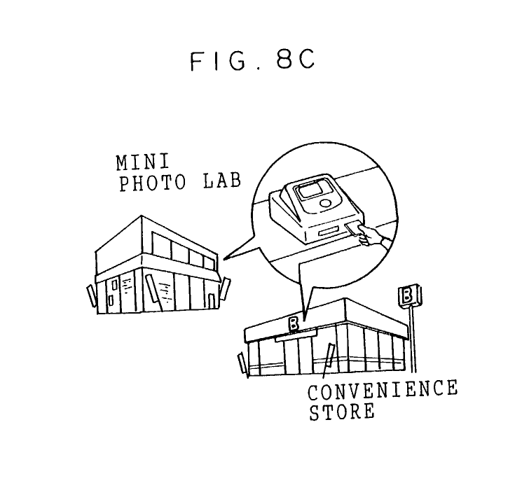

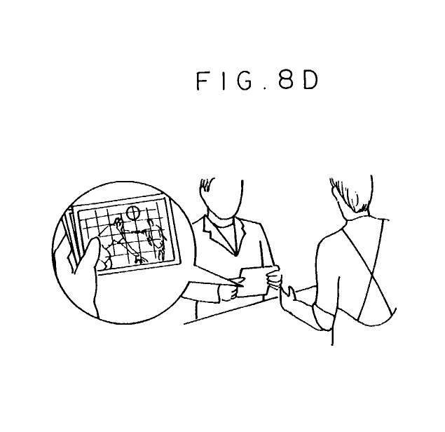

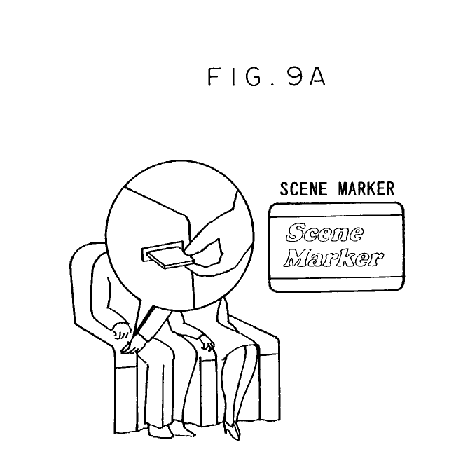

The contents of the image specifying information (to be specific, fixed information and scene specifying information) vary according to a display form of image content onto the display component, a form of disposing the writing device 36 to the display component, and the like. As an example, as shown in FIG. 8B, in an embodiment in which the electronic signboard has a plurality of image display units, the writing device 36 are provided in correspondence with the image display units, a still image is displayed in each of the image display units, the still image displayed in each of the image display units does not change in the same day, the scene marker is loaded in the writing device 36 corresponding to an image display unit displaying an image (still image) as an object of the printing order by the user. Consequently, for example, an electronic signboard ID for specifying the electronic signboard displaying an image, an image display unit ID for specifying an image display unit, a writing device ID for specifying a writing device, or an image ID (image title) for specifying an image is used as fixed information, and the date on which writing of image specifying information is instructed can be used as scene specifying information.

The above-described embodiment is an embodiment in which each of the writing devices 36 recognizes an image displayed on a corresponding image display unit as an image as an object of a printing order and writes the image specifying information. In the case where each writing device 36 can recognize an arbitrary image out of a plurality of images displayed on the display component (which may be a plurality of images simultaneously (in parallel) displayed on the display component or a plurality of images (for example, moving images) displayed on the display component in time sequence), for example, an electronic signboard ID for specifying an electronic signboard on which an image is displayed is used as fixed information. When the user designates an image as an object of a printing order via the input unit 88 (for example, designates a display position or the like), as scene specifying information, information for specifying a display position in a display screen of the display component, a moving image ID for specifying a moving image including the image as the object of the printing order, or information for specifying the image as the object of the printing order in the moving image (for instance, display date and time, a time code, or the like) is obtained and written into the storing unit 50 of the scene marker.

The contents of image specifying information to be written into the scene marker by the writing device 36 vary according to the kind of the distribution component for distributing image content, the kind of the display component for displaying image content, and the like. For example, when an image in moving images displayed on the display component 34A such as a TV or a PC for receiving a digital broadcast is the object of the printing order, the image as the object of the printing order can be specified by using, as the image specifying information, information such as a broadcast program ID for specifying an applicable broadcast program, time in which the applicable image is displayed, or a frame ID designated to an applicable image, or the like, the image as the object of the printing order can be specified.

In the embodiment, when the user designates an image as an object of the printing order via the input unit 88 (which can be replaced by various keys provided for a remote controller of a television) in the writing device 36 (for example, when the user wishes to make a printing order of an image displayed on the display component 34A, the image is designated by pressing a predetermined key in the input unit 88 like a shutter of a camera and instructs writing of the image specifying information, the writing device 36 provided in or attached to the display component 34A displaying a digital broadcast obtains information as described above as the image specifying information of the image of the object of the printing order (for example, a broadcast program ID can be obtained from a receiving device or the like, provided in the display component 34A (a frame ID can be similarly obtained, refer to JP-A No. 10-171027, and time information can be obtained from a built-in clock), and writes the obtained information into the storing unit 50 of the scene marker.

Recently, a system in which a home server having a large-capacity storing medium is disposed in a house of the user of a digital broadcast, data of the digital broadcast received in a predetermined period such as a week is stored in the home server, and the digital broadcast is reproduced and watched in desired time of the user by using the data stored in the home server is being studied. By using the technique, even in the case where there is a time lag between the time the user as the viewer of the digital broadcast recognizes an image to be stored as a photographic print in motion images of the digital broadcast being watched until time when operation of instructing a printing order, by using the data stored in the home server, the user can display an image desired to be stored as a photographic print or images before and after the image on the display component 34A such as a TV or PC. The image specifying information without a time lag can be obtained.

In the case where an image among motion images displayed on the display component 34A (screen) by screening a movie in a digital theater is an object of a printing order, an image as an object of the printing order can be specified by using information such as a movie ID for specifying a movie being screened (or a movie theater ID for specifying a movie theater in which the movie is screened and a hall ID for specifying a hall in which the movie is screened), the date when the user watches the movie, time at which the applicable image is displayed, or a frame ID designated to the applicable image.

In this embodiment, when the user designates an image as an object of a printing order via the input unit 88 (for example, when the user feels like making a printing order on a scene displayed on a screen, the user designates the scene by turning on a write instruction switch) and instructs writing of the image specifying information, the writing device 36 attached to the display component 34A on which a movie is screened (displayed) obtains information as described above as the image specifying information of the image as the object of a printing order (the movie ID (similarly, the frame ID) can be obtained from a screening facility or the like disposed in the digital theater and time information can be obtained from a built-in clock), and writes the obtained information into the storing unit 50 of the scene marker owned by the user.

By accessing a website (including an Internet live site) distributing image content via an information terminal (PC, portable telephone, a portable information device, or the like) having the function of making connection to the Internet by the user, in the case where an image in motion images displayed on a display (display component 34A) of the information terminal is the object of the printing order, the image as the object of the printing order can be specified by using, as the image specifying information, information such as a URL (Uniform Resource Locator) of the web site, a time at which the image is displayed or a frame ID designated to the image if the image is an image of one frame in motion images, the ID of the image if the image is one of a plurality of images open on the web site, and the like.

When the user designates an image as the object of the printing order via the input unit 88 of the writing device 36 or the input unit of an information terminal and instructs writing of the image specifying information, the writing device 36 provided in or attached to the information terminal obtains information as described above as the image specifying information corresponding to the image as the object of the printing order (the URL can be obtained from the information terminal, the time information can be obtained from a built-in clock, and the frame ID and the image ID can be obtained from the web site side via the information terminal), and writes the obtained information into the storing unit 50 of the scene marker.

The control unit 90 of the writing device 36 obtains, in addition to the image specifying information, low-resolution image data (thumbnail image data) of the image as the object of the printing order. The I/F section 86 of the writing device 36 may also write the thumbnail image data as scene specifying information into the storing unit 50 of the scene marker (refer to FIGS. 2A and 2B). A process of obtaining the thumbnail image data corresponds to an obtaining component described in the first embodiment, and the process of writing the obtained thumbnail image data into the storing unit 50 of the scene marker corresponds to the writing component described in the first embodiment.

The receiving machine will now be described. As shown in FIG. 1, a receiving unit 38 is connected to the MI network 16 (the receiving unit 38 may be connected to the MI network directly or via the computer 20 of the print finishing operator, see FIG. 1), and is mounted in any place all over the country such as a DPE shop, a convenience store, a shopping center, a theme park, and the like (an example of the appearance of the receiving machine 38 is shown in FIGS. 8C and 9C). The receiving machine 38 is constructed by including a display unit 74 taking the form of a CRT or LCD, capable of displaying an image, an input unit 76 to which various information is input by the user, an external I/F section 78 capable of transmitting/receiving information to/from the scene marker, a data transmitting/receiving unit 80 capable of transmitting/receiving data to/from the image order processor 12 via the MI network 16, and a control unit 82 for controlling operation of components of the receiving machine 38.

In the first ordering method, in the case where there is an image the user feels to memorize by storing the image as a photographic print in various image content distributed to the user, the user operates the input unit 88 of the writing device 36 provided in or attached to the display component 34A displaying the image (image as the object of the printing order), thereby allowing the writing device 36 to write the image specifying information (and thumbnail image data) of the image as the object of the printing order into the storing unit 50 of the scene marker owned by the user.

The user brings the scene marker in which the image specifying information is written in the storing unit 50 by the writing device 36 to the place where the receiving machine 38 is disposed. When the interface between the scene marker and the outside is of a contact type or a non-contact type whose communicable distance is relatively short, the user loads his/her scene marker into the loading unit of the receiving machine 38 and, after that, inputs information for instructing the order of printing the image as the object of the printing order (image in which the image specifying information is written in the scene marker) via the input unit 76 of the receiving machine 38, thereby displaying the intention of the printing order.

The control unit 82 of the receiving machine 38 reads image specifying information and user information via the external I/F section 78 from the storing unit 50 of the scene marker owned by the user expressing the intention of making the printing order, and transmits the read information to the image order processor 12 by the data transmitting/receiving unit 80. The process of reading the image specifying information from the storing unit 50 of the scene marker corresponds to the reading component described in the second embodiment. The process of transmitting the read image specifying information corresponds to a first receiving component described in the second embodiment. The process of reading user information from the storing unit 50 of the scene marker and transmitting it corresponds to the first receiving component described in the second embodiment.

In the first ordering method, processing (such as trimming) of an image and synthesis of an image with another image (for example, a template for generating a new year's card and a calendar) can be performed. The input unit 76 of the receiving machine 38 is constructed so that the user can instruct processing or synthesis of an image.

Among receiving machines, as shown in FIG. 1, a receiving machine 40 built in or attached to a display component 34B also exists (refer to a receiving machine 40A shown in FIG. 1). In a second ordering method, an image ordering component according to the invention is constructed by a scene marker and a receiving machine. An ordering method (second ordering method) using the receiving machine 40 will be described hereinbelow. Although not shown, the standard receiving machine 40 has, in a manner similar to the receiving machine 38, the display unit 74, input unit 76, external I/F section 78, data transmitting/receiving unit 80, and control unit 82. The control unit 82 has the function of obtaining the image specifying information in a manner similar to the control unit of the writing device 36.

In the second ordering method, when there is an image the user feels like memorizing by storing the image as a photographic print in various image content distributed to the user, the user designates the image as the object of the printing order via the input unit 76 of the receiving machine 40 provided in or attached to the display component 34B displaying the image (image as the object of the printing order, thereby expressing the intention of the printing order. Consequently, the control unit 82 of the receiving machine 40 reads the user information from the storing unit 50 of the scene marker held by the user expressing his/her intention to make the printing order, also obtains the image specifying information, and transmits the read user information and the obtained image specifying information to the image order processor 12 by the data transmitting/receiving unit 80, thereby receiving the printing order.

The second ordering method is not suitable for instructing processing, synthesis, or the like on an image at the time of ordering the printing but has an advantage such that it becomes unnecessary for the user to bring the scene marker and go to the place where the receiving machine 38 is mounted.

The receiving machine 40 takes not only the form (refer to the receiving machine 40A shown in FIG. 1) where the receiving machine 40 is connected to the image order processor 12 via the MI network 16 but also the form (refer to the receiving machine 40B shown in FIG. 1) in which the receiving machine 40 is connected to the image order processor 12 via the content distributor 42 and network 40. Specifically, for example, in a BS digital broadcast device, an uplink function (function of transmitting information at communication speed of 2400 bps from a reception side to a station side) is mounted. The receiving machine 40B provided in or attached to the display component 34B for receiving and displaying a BS digital broadcast uses the uplink function and transmits information such as the image specifying information to the image order processor 12 via a broadcast station as a content distributor 42 and the network 30.

Further, the receiving machine 40 can be provided in an information terminal such as a PC provided with the display unit as the display component, a portable telephone, or a portable information device. As an example, in FIG. 1, reference numeral “40C” is designated to a portable telephone, a PC, or the like having the function of the receiving machine. As long as an information terminal has therein a CPU, by installing a predetermined program to the information terminal, the information terminal can be provided with the function of the receiving machine and can transmit information such as the image specifying information to the image order processor 12 via the network 30.

Print Order Sequence (No. 1) in the First Ordering Method

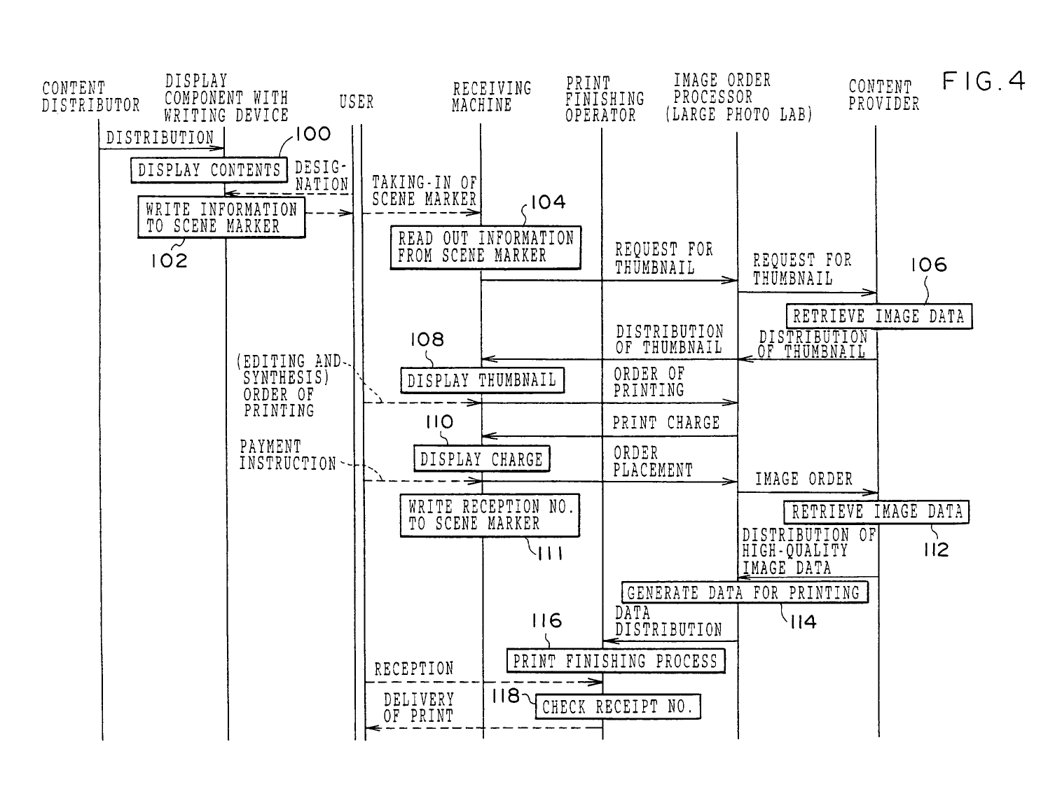

An example of the print order sequence in the first ordering method will be described by referring to FIG. 4. As described above, in the embodiment, various image content is distributed to various distributing components (display components) from various content distributors, and image content are displayed on the display components (in step 100 in FIG. 4 as an example).

A printing order in the first ordering method is made when an image the user feels like memorizing by storing the image as a photographic print is the image displayed on the display component 34A provided in or attached to the writing device 36 or in the case where the user desires to perform a process of processing or synthesizing on the image as the object of printing order. The user enters information for designating the image as the object of the printing order via the input unit of the writing device 36. The writing device 36 writes the image specifying information into the scene marker owned by the user (step 102 in FIG. 4). In the sequence shown in FIG. 4, thumbnail image data is not written into the scene marker. The scene marker in the first ordering method corresponds to the portable device described in a fourth embodiment.

After the image specifying information is written into the scene marker, the user brings the scene marker to the place where the receiving machine 38 is mounted and enters the information of instructing the order of printing the image as the object of the printing order via the input unit 76 of the receiving machine 38. The external I/F section 78 of the receiving machine 38 reads the image specifying information and user information from the storing unit 50 of the scene marker owned by the user (step 104 in FIG. 4). Subsequently, the receiving machine 38 adds the image specifying information and user information read out from the storing unit 50 of the scene marker and receiving machine ID for specifying the receiving machine 38 itself to information indicative of a transmission request of data of a thumbnail image, and transmits the information to the image order processor 12 via the transmitting/receiving unit 80, thereby requesting the image order processor 12 to transmit data of a thumbnail image of the image as the object of the printing order specified by the image specifying information.

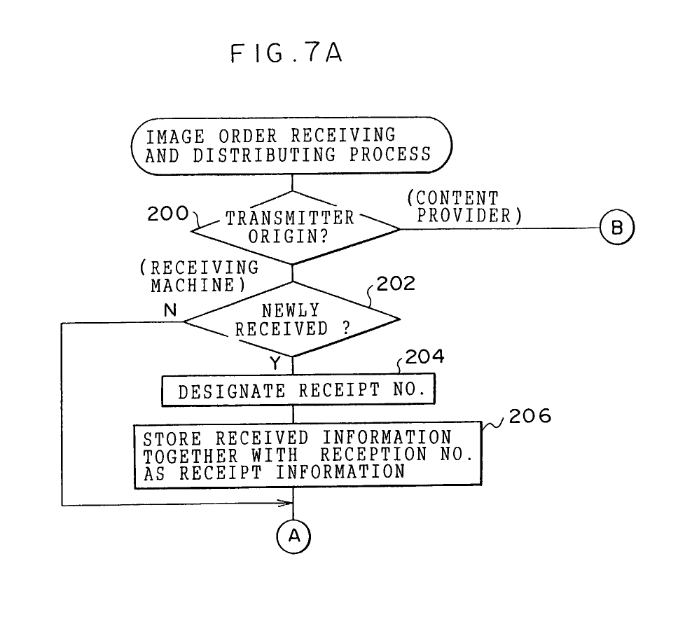

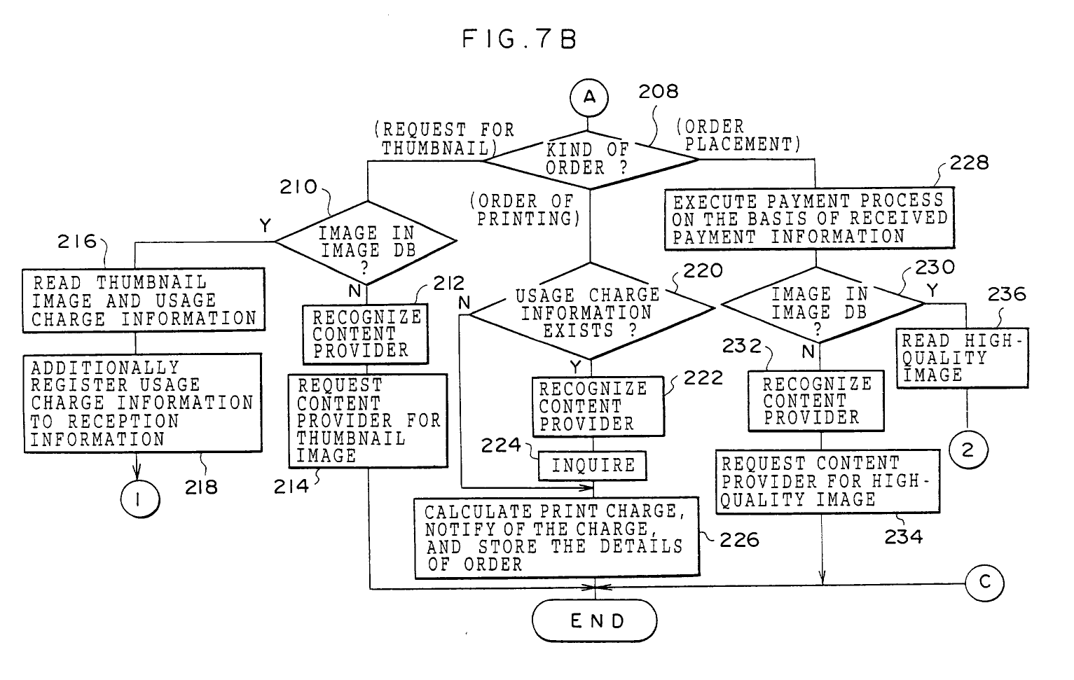

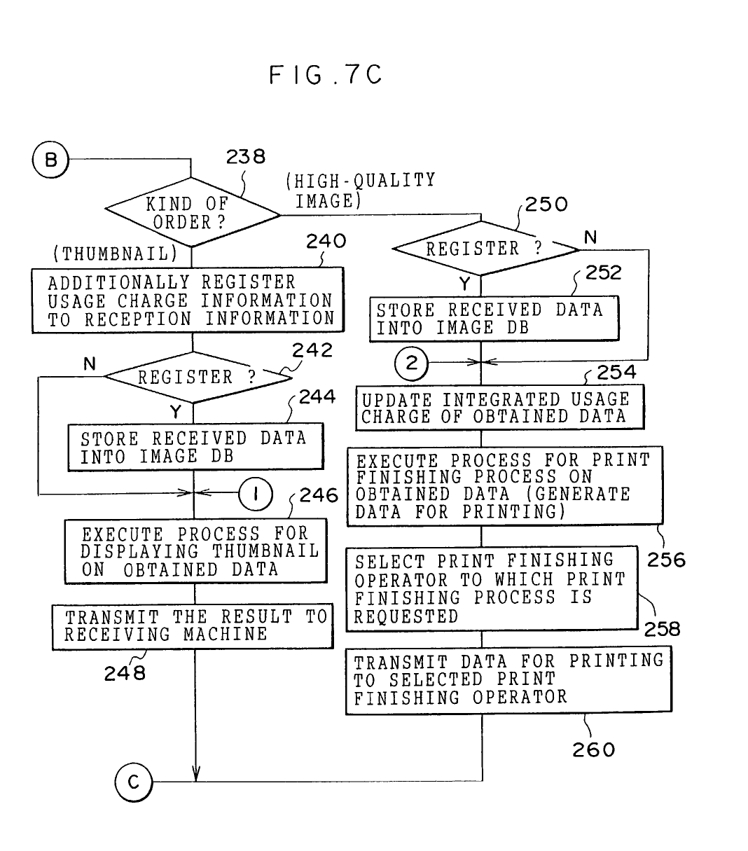

When information is received from the outside, the image order processor 12 executes an image order receiving and distributing process shown in FIGS. 7A to 7C. In the image order receiving and distributing process, first, in step 200, whether the transmitter of the information received this time is the receiving machine or content provider (or contents manager) is determined. In the case where the transmitter of the information is the receiving machine, the program advances to step 202 and determines whether the information received this time is information corresponding to a new printing order or not on the basis of the contents of the information received.

Since a number of printing orders are received and processed in parallel, the image order processor 12 designates a reception number for identifying each printing order to each of all of the printing orders received. The reception number of a corresponding printing order is added to information regarding to the printing order to which the reception number is designated, transmitted/received between the image order processor 12 and the receiving machine or content provider.

Consequently, if the reception number is not added to the information received, step 202 is affirmatively determined and the program advances to step 204 where reception number is given to a new printing order corresponding to the information received this time. In step 206, the information (receiving machine ID, image specifying information, and user information) received from the receiving machine 38 is associated with the reception number and stored as reception information into a memory or the like. After that, the program shifts to step 208. If step 202 is negatively determined, the program advances to step 208 without performing any process.

In step 208, on the basis of the contents of the information received from the receiving machine, the contents of a request or notification indicated by the information received from the receiving machine is determined. When it is determined in step 208 that the receiving machine requests transmission of data of a thumbnail image of an image as an object of the printing order, the program shifts to step 210 and whether data of the thumbnail image of the image as an object of the printing order requested to be transmitted by the receiving machine is stored in an image database (DB) provided for the HDD 14 or not is determined.

The image DB is a database provided to store data of an image, which is frequently ordered to be printed (thumbnail image data and high-quality image data). In the case where the data of the requested thumbnail image is not stored in the image DB, step 210 is negatively determined and the program shifts to step 212 where the content provider (or manager) storing the image data of the image as an object of the printing order is recognized.

The content provider (or manager) can be recognized in such a manner that a content provider/manager DB in which image identification information for identifying an image of image data stored in the contents storing unit 26 by each content provider (or manager) is prestored in association with an ID for identifying the content provider (or manager) is provided for the HDD 14, and received image specifying information is checked with the image identification information stored in the contents provider/manager DB to retrieve the content provider (or manager) storing the image data of the image as an object of the printing order expressed by the received image specifying information.

In the following step 214, the image specifying information and the reception number is added to information indicative of a transmission request of the thumbnail image data, and the resultant information is transmitted to the computer 28 of the content provider (or manager) recognized in step 212 via the network 30, thereby requesting the content provider (or manager) to transmit the thumbnail image data of the image as an object of the printing order, and the image order receiving and distributing process is once finished. As described above, the image specifying information varies according to the kind of the distribution component for distributing the image content and the like. Consequently, the image specifying information received from the receiving device may be converted to a predetermined code system information by which an image can be easily retrieved on the content provider (or manager) side and the resultant may be transmitted.

The computer 28 of the content provider (or manager) received the information searches the contents storing unit 26 with the received image specifying information as a key, and reads the thumbnail image data of the image as the object of the printing order and charge information from the contents storing unit 26 (step 106 in FIG. 4). It is also possible to store only high-quality image data in the contents storing unit 26, read out the high-quality image data, and reduce the resolution of the read out data, thereby obtaining the thumbnail image data. The computer 28 adds the received reception number to the read thumbnail image data and charge information and transmits the resultant to the image order processor 12 via the network 30.

On receipt of information, the image order processor 12 executes an image order receiving and distributing process (FIGS. 7A to 7C). When the transmitter of the received information is the computer 28 of the content provider (or manager), the program advances from step 200 to step 238 where the process is branched in accordance with the received information. If the information received from the computer 28 is thumbnail image data, the program shifts from step 238 to step 240 where the corresponding reception information is retrieved by using the reception number added to the received information as a key, the charge information added to the received information is added to the corresponding reception information, and the resultant is registered.

In the following step 242, whether the received thumbnail image data is registered in the image DB or not is determined. In the case where the image as an object of the printing order of this time is an image which is frequently ordered to be printed, step 242 is affirmatively determined, and the process advances to step 244 where the received thumbnail image data and charge information is registered in the image DB. After that, the program advances to step 246. If the step 242 is negatively determined, without performing any process, the program shifts to step 246. Consequently, when a printing order is made again with respect to the image of which thumbnail image data and the like is stored in the image DB, it becomes unnecessary to re-request the content provider (or manager) for the information of the image.

Specifically, if the data of the thumbnail image of the image as the object of the printing order requested to be transmitted by the receiving machine is stored in the image DB in step 210, step 210 is determined affirmatively. The program shifts to step 216 where the thumbnail image data of the image (image as the object of the printing order) requested to be transmitted by the receiving machine and charge information is read out from the image DB. In the following step 218, the charge information read from the image DB is added to the corresponding reception information and the resultant is registered. After that, the program advances to step 246. In such a manner, the frequency of requesting the content provider (or manager) to transmit information (thumbnail image data and high-quality image data) can be effectively reduced.

In the following step 246, a process of displaying the thumbnail image data obtained by either receiving it from the content provider (or manager) or reading it from the image DB as a thumbnail image onto the display unit 74 of the receiving machine 38 is performed. As the process, for example, an image process such as color space conversion for displaying a thumbnail image of a proper picture quality on the display unit 74 can be mentioned. Other processes may be also performed such as decompression of reception data in the case where compressed thumbnail image data is transmitted from the content provider (or manager) in consideration of reduction in time required to transmit/receive thumbnail image data or decoding of receiving data in the case where coded thumbnail image data is transmitted from the content provider (or manager) in consideration of prevention of leakage of the thumbnail image data to a third party.

In step 248, after the reception number is added to the thumbnail image data subjected to the process of step 246, a receiving machine to which the information is to be transmitted is recognized on the basis of the receiving machine ID stored as reception information, and the information is transmitted to the recognized receiving machine, the image order receiving and distributing process is once finished.

The receiving machine 38, which has received from the information including the thumbnail image data from the image order processor 12 displays a thumbnail image on the display unit 74 by using the received information (refer to step 108 in FIG. 4). The user who has entered the information of instructing the printing order of the image as the object of the printing order via the input unit 76 of the receiving machine 38 can recognizes the image ordered to be printed by himself/herself by visually recognizing the thumbnail image displayed on the display unit 74. The process corresponds to a recognizing component described in the second embodiment.

In the case where the image as the object of the printing order is an image obtained by photographing motion images (such as a movie) in accordance with an instruction of the user, there is the possibility that a time lag occurs between the time when the user recognizes that there is an image desired to be stored as a photographic print in motion images being viewed and time when the user performs an operation of instructing a printing order. Consequently, it is also possible to display, as thumbnail images, motion images including the image specified by the image specifying information and images before and after the specified image so that the user can determine whether the timing at which the image is photographed is proper or not.

The user who has confirmed that the thumbnail image displayed on the display unit 74 is the same image as the image as the object of the printing order made by himself/herself enters information indicative of details of the printing order (such as print size, the number of sheets to be printed, and the like) via the input unit 76 of the receiving machine 38. In the case where the user desires processing of the image as the object of the printing order and synthesis with other image, the user also enters information of instructing the processing or synthesis on the image as the object of the printing order. By displaying an image (for example, template for generating a new year's card or calendar) which can be synthesized with the image as the object of the printing order on the display unit 74, the image data to be presented to the user may be transmitted from the image order processor 12 to the receiving machine 38 or preliminarily stored in the receiving machine 38.

When the kind of the printing order desired by the user is determined from the various information entered by the user via the input unit 76, the receiving machine 38 adds the information indicative of the details of the printing order determined and the reception number to the information indicative of the presence of the printing order (in the case where the processing or synthesis of the image is instructed by the user, the information indicative of the instruction is also added, these information being corresponding to “information indicative of the details of a designated printing order” described in a third embodiment). The resultant information is transmitted to the image order processor 12.

In the image order processor 12 which has received the above information, steps 200, 202, and 208 are sequentially executed in the image order receiving and distributing process (FIGS. 7A to 7C), and advances from step 208 to step 220. In step 220, whether the charge information of the image as the object of the printing order exists or not is determined. In the order sequence shown in FIG. 4, the charge information is obtained on receipt of the thumbnail image data. Consequently, step 220 is determined negatively and the program advances to step 226.

In step 226, photographic print generation charge is calculated on the basis of the information indicative of the details of the printing order received from the receiving machine 38, and an image usage charge indicated by the usage charge information additionally registered to the reception information in step 240 or 218 is added to the photographic print generation charge, thereby calculating a printing fee to be charged to the user. By transmitting the information indicative of the calculated printing fee to the receiving machine 38, the printing fee is notified to the receiving machine 38. By additionally registering the information received from the receiving machine 38 to the reception information, the details of the printing order are stored. After that, the image order receiving and distributing process is once finished.

The receiving machine 38, which has received the information indicative of the printing fee displays, the printing fee indicated by the received information onto the display unit 74 (refer to step 110 in FIG. 4), so that the user can easily recognize the printing fee. The process corresponding to a first receiving component described in the third embodiment. By entering the information instructing settlement via the input unit 76 by the user who has recognized the printing fee, the printing order instructed by the user before is determined. When the scene marker owned by the user has the function of making a payment, the receiving machine 38 performs a process for the payment of the determined printing order.

Specifically, in the scene marker having the function of making a payment, for example, payment information (information necessary for a payment) is preliminarily written in a storing component such as a nonvolatile memory built in the control unit 52. As the payment information, for example, if the payment method is a credit card, credit card information indicative of the number of the credit card of the user can be used. If the payment method is a prepaid card, rates indicative of the remaining rates, which can be used for the printing order, can be used.

The receiving machine 38 performs communication with the control unit 52 of the scene marker of the user in accordance with a predetermined order, thereby requesting the control unit 52 to transmit payment information and receiving the payment information transmitted from the control unit 52. The receiving machine 38 adds the payment information received from the scene marker and the reception number to the information indicating that the printing order is placed, and transmits the resultant to the image order processor 12. The receiving machine 38 writes the reception number to the storing unit 50 of the scene marker for collision at the time of delivery of the print (refer to step 111 in FIG. 4). The writing of the reception number corresponds to the first receiving component described in the second embodiment.

On the other hand, the image order processor 12 which has received the information sequentially executes the processes in steps 200, 202, and 208 in the image order receiving and distributing process (FIGS. 7A to 7C) and shifts from step 208 to step 228. In step 228, the payment process is performed on the basis of the payment information included in the information received from the receiving machine 38.

For example, if the payment method is a credit card, the credit card information is transmitted as payment information from the receiving machine 38. The information such as the credit card information received from the receiving machine 38, user information stored as reception information, and the printing fee received this time is transmitted to a computer (not shown) of a settlement agency connected to the network 30 via a communication line and a payment process is requested to the settlement agency. Reception of a report of completion of settlement from the settlement agency is confirmed and the receiving machine 38 is notified of completion of the payment. In this case, for example, the receiving machine 38 makes the display unit 56 to display a message, thereby notifying the user of completion of the settlement of the printing order received this time.

If the payment method is a prepaid card, the rate information is transmitted as payment information from the receiving machine 38. The rates corresponding to the printing fee of the order received this time is subtracted from the rates indicated by the rate information received from the receiving machine 38, and the resultant rate information indicative of the rates after the subtraction is transmitted to the receiving machine 38. In this case, the receiving machine 38 performs communication with the control unit 52 of the scene marker in a predetermined procedure, thereby storing the rate information received from the image order processor 12 into the scene marker and displaying the message onto the display unit 56. In such a manner, the user is notified of completion of the payment of the printing order received this time and the remaining rates.

The process of the receiving machine 38 in the series of processes corresponds to the payment process component described in the third embodiment.

After completion of the payment process, the image order processor 12 moves to step 230 where whether or not high-quality image data of the image as the object of the printing order is stored in the image DB or not is determined on the basis of the image specifying information of the image as the object of the printing order stored as reception information. If the determination in step 230 is negative, the program advances to step 232 where the content provider (or manager) storing the image data of the image as the object of the printing order is recognized on the basis of the image specifying information stored as reception information in a manner similar to the above-described step 212.

In the following step 234, the image specifying information and reception number is added to the information indicative of the transmission request of the high-quality data, and the resultant information is transmitted to the computer 28 of the content provider (or manager) recognized in step 232 via the network 30, thereby requesting the content provider (or manager) to transmit high-quality image data of the image as the object of the printing order. After that, the image order receiving and distributing process is finished once.

The computer 28 of the content provider (or manager) who has received the information searches the contents storing unit 26 with the received image specifying information as a key, and reads the high-quality image data of the image as the object of the printing order from the contents storing unit 26 (refer to step 112 in FIG. 4). The computer 28 adds the reception number to the read high-quality image data and transmits the resultant information to the image order processor 12 via the network 30.

Since the network 30 according to the embodiment has security of a lower level as compared with the MI network 16, to prevent leakage of the high-quality image data to a third party other than the content provider (or manager) and the image order processor (large photo lab), it is desirable that high-quality image data transmitted form the content provider (or manager) is image data which is at least coded. The coding may be performed after the image data is read out from the contents storing unit 26 or coded data may be stored in the contents storing unit 26.

The image order processor 12 which has received the information sequentially executes the processes of steps 200 and 238 in the image order receiving and distributing process (FIGS. 7A to 7C). If information received from the computer 28 is high-quality image data, the program advances from step 238 to step 250. In step 250, whether the received high-quality image data is registered in the image DB or not is determined. In the case where the image as the object of the printing order of this time is an image, which is frequently ordered to be printed, step 250 is affirmatively determined and the program advances to step 252 where the received high-quality image data is registered in the image DB. After that, the program advances to step 254. If step 250 is negatively determined, the program advances to step 254 without performing any process. In such a manner, when the printing order is made again with respect to the image of which high-quality image data or the like is stored in the image DB, it is unnecessary to make a request of the information of the image data again to the content provider (or manager).

To be specific, when the high-quality image data of the image as the object of the printing order requested to be transmitted by the receiving machine is stored in the image DB, step 230 is affirmatively determined and the program advances to step 236. The high-quality image data of the image as the object of the printing order is read out from the image DB and, after that, the program advances to step 254. In such a manner, the frequency of requesting the content provider (or manager) to transmit high-quality image data can be effectively reduced.

In the embodiment, an integrated value of the image usage charges to be paid to the content provider or the like with respect to images of which photographic prints are ordered by the user to be generated is stored in the HDD 14. In step 254, a process of updating the integrated value of corresponding image usage charges when high-quality image data obtained by being received from the content provider (or manager) or read out from the image DB is used for the printing order of this time is performed. The image usage charges are read out periodically (for example, every month) and totaled as an integrated value for each payee (content provider or manager, or payee of a charge of the rights to one's portrait), and the total value is automatically credited to an account preliminarily designated by the payee. Each time the image usage charges are credited, the integrated value of the image usage charges is cleared (to zero).

In step 256, a process of generating image data for printing (image data on which a print finishing operator can easily perform a print finishing process) from the obtained high-quality image data (refer to step 114 in FIG. 4). As the process of generating the image data for printing, first, decoding of coded high-quality image data received from the content provider (or manager) can be mentioned.

The coding and decoding of data is often performed by using a “key”. The common key system using the same key for coding and decoding can execute a coding process at high speed. However, the system has a problem such that when a receiving machine decodes data coded by a transmitter, the key used by the transmitter and the key used by the receiving machine have to coincide with each other, but transmittance/reception of the key between them deteriorates security.

On the other hand, the public key system is a system in which a coding key used for coding and a decoding key used for decoding are different from each other, the coding key is open to the public but the decoding key is not open. A transmitter encodes transmission data by using the public key of a receiving machine, and the receiving machine decodes the reception data by using the secret key, so that security is high. Consequently, in the embodiment, high-quality image data is coded and decoded by using the public key system. As known coding software employing the public key system, an international version of PGP (Pretty Good Privacy), S/MINE (Secure Multipurpose Internet Mail Extension) and the like are known and, they can be used.

Since the high-quality image data has a high resolution, a data amount is large and it may take long time to transmit/receive data. It is therefore preferable to compress transmission data at the time of transmission of high-quality image data from the content provider (or manager) to the image order processor 12. In this case, in step 256, as one of the processes of generating image data for printing, compressed high-quality image data received from the content provider (or manager) is decompressed (reconstructed). For compression and decompression of data, known various algorithms can be employed.

As one of the processes for generating image data for printing in step 256, a process according to the details of the printing order from the user may be performed. Specifically, for example, a resolution conversion (pixel density conversion) according to the print size designated by the user, processing (such as trimming) on image data in accordance with the designation of the user, synthesis of image data (synthesis with a template), and the like can be mentioned.

Further, as one of the processes for generating image data for printing in step 256, an imaging process for improving picture quality may be also performed. Specifically, for example, a color and density correcting process including gradation conversion and color conversion, color space conversion for reproducing an image of an object of the printing order as an image in proper colors on a recording medium such as printing paper, a hyper tone process for compressing gradation of a very-low frequency luminance component of an image, a hyper sharpness process for emphasizing sharpness while suppressing graininess, a defect correcting process for correcting a defect in an image caused by pixel dropout or the like of an image pickup sensor, and the like can be mentioned. By the process, the quality of the photographic print generated by the print finishing operator can be improved.

By performing at least one of the above-described processes, a facility to be mounted on each print finishing operator to realize an environment capable of printing various image content can be simplified, and the image distributing and order processing system 10 according to the embodiment can be easily configured.

When it takes long time to receive image data for printing transmitted from the image order processor 12 due to, for example, low speed of data communication speed between the image order processor 12 and the computer 20 of the print finishing operator and it disturbs operations of the print finishing operator, a process of compressing image data once generated may be performed as one of the processes of generating image data for printing. In the case such that the security of the communication line between the image order processor 12 and the computer 20 of the print finishing operator is low, a process of coding image data once generated may be performed.

In the following step 258, a print finishing operator to which the print finishing process is requested is selected. Specifically, for example, user information stored as one of reception information is referred to and a print finishing operator closest to the user's address may be selected. When the user designates the print finishing operator via the input unit 76 of the receiving machine 38, the designated print finishing operator may be selected. In step 260, information indicative of the details of the printing order, user information, and reception number are added to the image data for printing generated in step 256, and the resultant information is transmitted to the print finishing operator selected in step 258 via the MI network 16.

The print finishing operator which has received the image data for printing via the MI network 16 and computer 20 performs a print finishing process by the digital printing system 22 by using the image data for printing received from the image order processor 12 in accordance with the details of the printing order indicated by the received information (refer to step 116 in FIG. 4). When the user comes to a predetermined print delivery site (for example, a place where the receiving machine 38 is mounted like a DPE shop or a convenience store), the identification is authenticated by checking the user information and reception number stored in the storing unit 50 of the scene marker of the user with the user information and reception number received from the image order processor 12 (refer to step 118 in FIG. 4). After that, the result of the printing order made by the user (photographic print generated by the print finishing process) is given to the user.

Print Order Sequence (No. 2) in the First Ordering Method

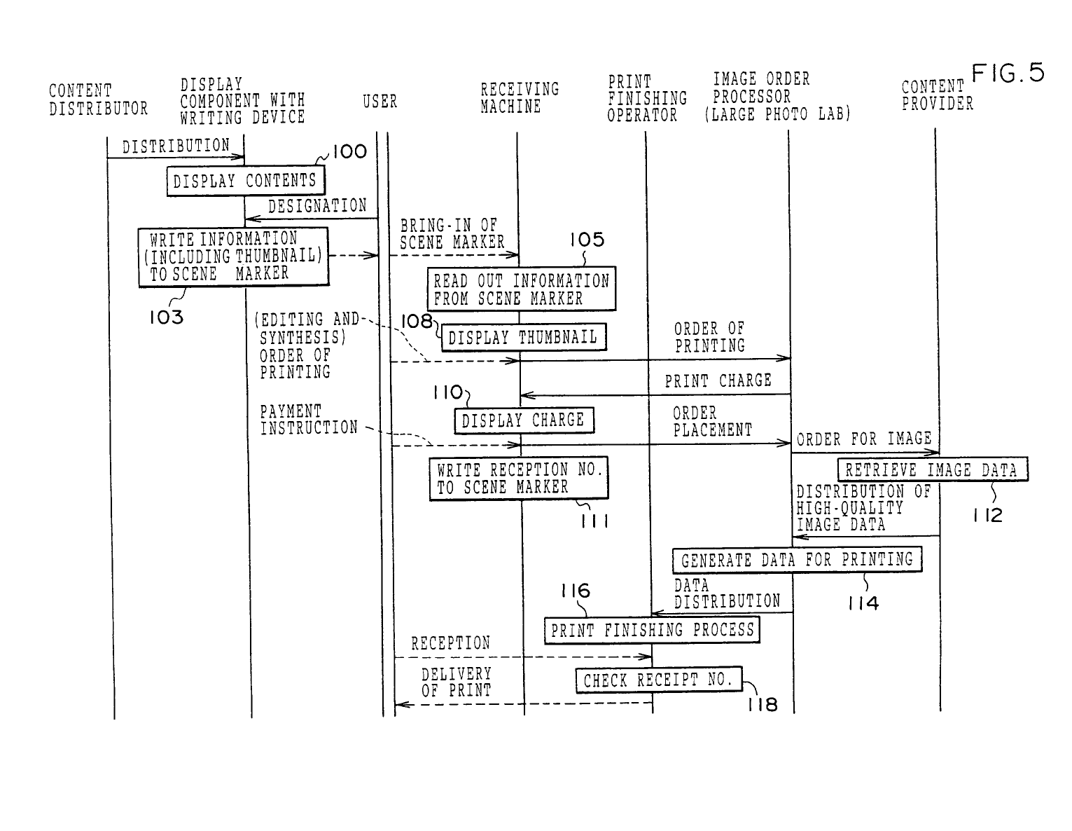

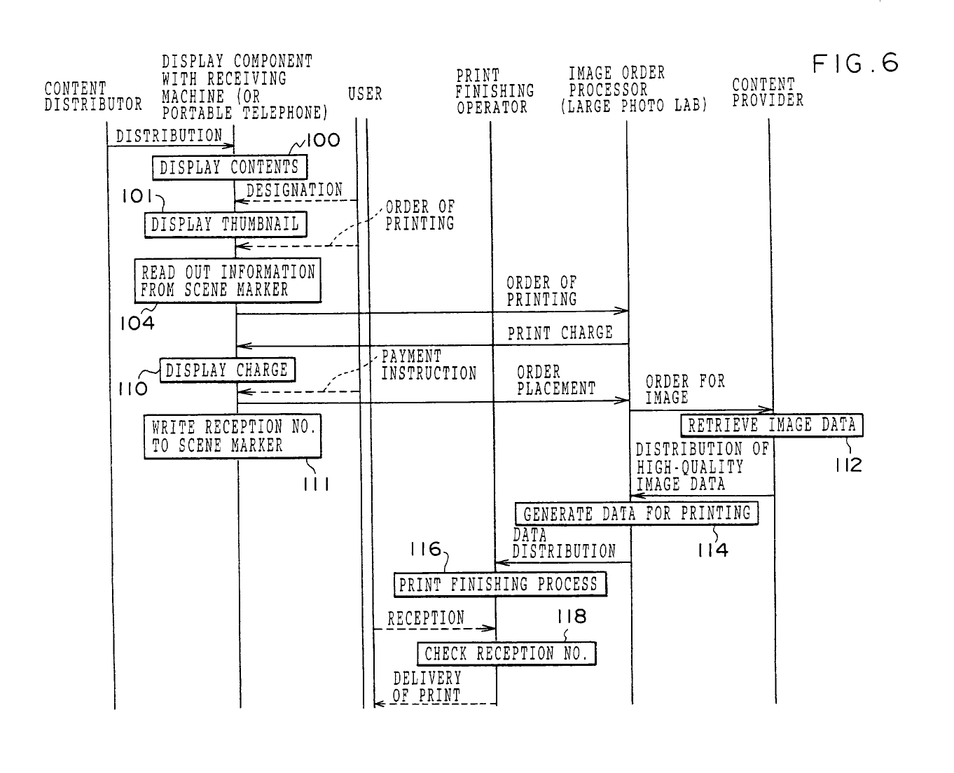

Another example of the print order sequence in the first ordering method will now be described by referring to FIG. 5 only with respect to a portion different from the print order sequence shown in FIG. 4.

In the print order sequence shown in FIG. 5, when the user enters information designating the image as the object of the printing order via the input unit 88 of the writing device 36, the writing device 36 obtains the image specifying information, writes it into the scene marker of the user, and also obtains thumbnail image data of the image as the object of the printing order and writes it into the scene marker (refer to step 103 in FIG. 5). The thumbnail image data can be obtained in such a manner that the display component 34A stores image data for display for a predetermined period and, when the display component 34A is notified of designation of an image of a printing order from the writing device 36, thumbnail image data of the image as the object of the printing order is output from the stored image data for display to the writing device 36.

When the image specifying information and thumbnail image data is written into the scene marker, the user brings the scene marker to the place where the receiving machine 38 is installed and enters the information which instructs the printing order of an image as the object of the printing order via the input unit 76 of the receiving machine 38, thereby expressing the intention of making the printing order. The external I/F section 78 of the receiving machine 38 reads the image specifying information, user information, and thumbnail image data from the storing unit 50 of the scene marker of the user (refer to step 105 in FIG. 5).

The receiving machine 38 displays a thumbnail image on the display unit 74 by using the thumbnail image data read from the scene marker (refer to step 108 in FIG. 5). Consequently, the thumbnail image can be displayed on the display unit 74 without transmitting thumbnail image data from the image order processor 12 (and the content provider). The user who entered the information of instructing the printing order can confirm the image of which print is ordered by the user himself/herself, so that the data amount to be transferred among the receiving machine 38, the image order processor 12, and the content provider can be reduced. The process corresponds to a confirming component described in the second embodiment.

Since the print order sequence after displaying the thumbnail image is almost the same as that shown in FIG. 4, its description will not be repeated. In the case of omitting acquisition of thumbnail image data as described above, the user who confirmed the thumbnail image displayed on the display unit 74 enters information indicative of the details of the printing order. When the information is received by the image order processor 12, the image order processor 12 has not received the printing order (not stored reception information) Except for the case where the data of the image as the object of the printing order is already stored in the image DB, the image usage charge of the image as the object of the printing order is unknown.

Consequently, in the image order receiving and distributing process (FIGS. 7A to 7C) executed by the image order processor 12, in a case as described above, first, by affirmatively determining step 202, the reception number is designated (step 204) and the reception information is stored (step 206). By affirmatively determining step 220, the program advances to step 222 where, in a manner similar to the step 212 described above, the content provider (or manager) storing the image data of the image as the object of the printing order is recognized. After that, in the following step 224, image specifying information and reception number are added to information indicative of inquiry of an image usage charge, and the resultant information is transmitted to the content provider (or manager) recognized in step 222 to inquire of the image usage charge of the image as the object of the printing order. By using the image usage charge notified from the content provider (or manager), the process of calculating a print fee or the like is performed (step 226).

Print Order Sequence in a Second Ordering Method

An example of a print order sequence in a second ordering method will be described with respect to only a portion different from the above-described print order sequence by referring to FIG. 6.

A print order in the second ordering method is made when an image the user feels like memorizing by storing it as a photographic print is an image displayed on the display component 34B (or an information terminal (for example, the display component and a portable telephone, a PC, or the like designated by reference numeral “40C” in FIG. 1) having the function of the receiving machine, which will be called as the receiving machine 40 and the display component 34B). The user enters information of designating an image as an object of the print order via the input unit of the receiving machine 40.

The receiving machine 40 thereby obtains the image specifying information and thumbnail image data in a manner similar to the writing device 36 in the print order sequence shown in FIG. 5 and allows the thumbnail image to be displayed on the display unit of the receiving machine 40 or the like (refer to step 101 in FIG. 6). The acquisition of the image specifying information corresponding to the obtaining component described in the third embodiment. Consequently, without transmitting the thumbnail image data from the image order processor 12 (and the content provider), the thumbnail image can be displayed on the display unit. The user who has entered the information of instructing the print order is allowed to confirm the image of the print order made by the user himself/herself. Thus, the amount of data to be transmitted/received among the receiving machine 40, the image order processor 12, and the content provider can be reduced.

Since the receiving machine 40 is provided in or attached to the display component 34B, at the timing at which the user enters the information of designating the image as the object of the print order, an image the user feels like storing as a photographic print is displayed on the display component 34B or, mostly, immediate after the image is displayed on the display component 34B. Consequently, the thumbnail image may not be displayed.

When the user who confirmed the thumbnail image displayed on the display unit 74 enters the information indicative of the details of the print order and the information indicative of the details of the print order the details of the print order desired by the user are consequently determined, the external I/F section 78 of the receiving machine 40 reads the user information from the storing unit 50 of the scene marker of the user (refer to step 104 in FIG. 6). The scene marker in the second ordering method corresponds to a portable device described in a fifth embodiment.

The receiving machine 40 adds information indicating the details of the determined print order, obtained image specifying information, user information read from the storing unit 50 of the scene marker, and receiving machine ID for specifying the receiving machine 38 itself to information indicative of the presence of the print order, and transmits the resultant information to the image order processor 12. The print order sequence after transmitting the information is almost the same as the print order sequence shown in FIG. 5, so that its description will not be repeated.

In the second ordering method, information is transmitted to the image order processor 12 without writing the image specifying information obtained by the receiving machine 40. The information read in step 104 in FIG. 6 is therefore only user information. The user information can be entered by the user via the input unit of the receiving machine 40 or the like. Therefore, in the second ordering method, the user does not always have to have the scene marker but may have a simple recording medium on which only user information is recorded (such as a magnetic card or a card on which a bar code is recorded; the card can have the payment function like a credit card). The user can make a print order even the user does not have neither a scene marker nor a simple recording medium.

In the case where the user does not have a scene marker or any other simple recording media, the user has to enter the user information each time a print order is made. Consequently, a heavy burden is applied on the user. When the user has only a simple recording medium, there is a fear that the user information may be read out or forged by a malicious third party. Therefore, it is desirable that the user has a card-type scene marker or a scene marker built in a portable telephone.

Specific Example of Business Model

A specific example of business models realized by the image distributing and order-processing system 10 according to the embodiment will now be described with respect to each of various image content. The models described hereinbelow are just an example and the invention is not limited to the models.

Model (1): Image of Impressive Scene in Sports Event

A professional photographer as a content provider captures impressive scenes such as a fine play scene, a big home-run scene, and a goal scene in stadiums where sports events are held. To provide the photographed impressive scenes and to be paid for the values, the professional photographer brings (or on-line transfers) the image data of the impressive scenes photographed to an administrator (content distributor) for administrating an electronic signboard (display component) installed in the stadium during a game or after the game. The administrator of the electronic signboard displays the data brought from the professional photographer as images of impressive scenes onto the electronic signboard so as to receive timely print orders. In such a manner, the images of the impressive scenes are presented to the users who come to the stadium (refer to FIG. 8A).

In the example shown in FIGS. 8A to 8D, the electronic signboard is constructed by a plurality of image display units and the write device 36 is provided for each of the image display units. The user who finds an image the user desires to memorize by storing the image as a photographic print in images displayed on the plurality of image display units of the electronic signboard loads a scene marker into the writing device 36 provided in correspondence with the image display unit on which the image is displayed (refer to FIG. 8B), makes the image specifying information of the image as an object of the print order and the like written into the scene marker by operating the input unit 88 of the writing device 36, and loads the scene marker into the receiving machine 38 provided separately from the electronic signboard to make the print order of the image (refer to FIG. 8C).

An order of printing the image can be made by, in place of the first ordering method, the second ordering method by using the receiving machine 40 provided in or attached to the electronic signboard and a portable telephone having the function of the receiving machine owned by the user.

After placing the print order by processes such as display of charges, high-quality image data of an image as an object of the print order is transferred from the content provider (or manager), and a photographic print generated by using the image data is given to the user (refer to FIG. 8D) After the print order is placed, the payment process is performed. The usage charge of the image, which is ordered to be printed, is paid to the content provider (and the manager), and the content distributor is also paid for the distribution of the image content.

Other examples of the image content to which the model (1) can be applied are images of works of art photographed by a professional photographer as a content provider in a museum where photography by the general public is forbidden (which are distributed to the users (visitors of the museum) by displaying the images on an electronic signboard disposed at the exit of the museum or the like), and images of live scenes in full gear photographed by a professional photographer as a content provider in a live show (which are distributed to the users (audience of the live show) by displaying the images on an electronic signboard disposed at the exit or the like of the hall at the end of the live show).

Model (2): Image of One Scene of a Movie

A movie created by a movie creator as a content provider is brought in a digital theater (content distributor) through a movie distributing agency and is screened (distributed) in the digital theater. In such a manner, the movie is presented as image content to the user who comes to the digital theater. As shown in FIG. 9A, the writing device 36 are buried in seats (not necessarily all of the seats) of the digital theater. The user sitting on the seat loads his/her scene marker into the writing device 36.

The user who found a scene the user desires to memorize by storing the scene as a photographic print in a movie displayed on the screen of the digital theater operates (for example, press a write instruction button) the input unit 88 of the writing device 36 buried in the seat, thereby writing image specifying information of the image as an object of the print order into the scene marker (refer to FIG. 9B). The user loads the scene marker into the receiving machine 38 provided separately from the digital theater to make a print order of the image (refer to FIG. 8C). Since the sequence after the print order is made is the same as that of the model (1), its description will not be repeated.

Model (3): Images of Digital Broadcast

A program created by a program creator as a content provider is brought in a broadcast station (content distributor) of a digital broadcast and distributed by the broadcast station. By receiving a digital broadcast by the user on a display (display component) of an electronic device such as a television or PC having the function of receiving a digital broadcast, motion images of the digital broadcast are displayed on the display (display component) of the electronic device.

The user who finds that there is a scene to remember by storing the scene as a photographic print in motion images of the digital broadcast displayed on the display of the electronic device such as a television or PC makes an order of printing the scene either by the first ordering method by using the writing device 36 provided in or attached to the electronic device and the receiving machine 38 provided separately from the electronic device or the second ordering method by using the receiving machine 40 provided in or attached to the electronic device (or a portable telephone having the function of the receiving machine owned by the user). The sequence after the print order is made is the same as that in the models (1) and (2), so that its description will not be repeated.

In the model (3), the image content to be distributed are not limited to moving images but also include still images. As the number of channels increases in association with starts of digital broadcasts, a channel of a data broadcast for broadcasting excellent still image content (still images of, for example, works of famous illustrators, planetary pictures photographed by the Subaru telescope, and scenes exciting the emotions of a traveler such as “the front approach of the Shimizu temple after rain in Kyoto in fall” and “scenery of pine trees over which ropes are stretched from the top to the lower branches to protect them from snow damage in Kenrokuen in Kanazawa in late fall”) can be established. In a digital broadcast, the same scene can be broadcast at multiple angles. The multiple angles have an advantage that a single scene can be seen from a plurality of different directions. By broadcasting still image content from multiple angles, the user can make an order of printing a favorite scene and an image at a favorite angle.

In the case of making a print order by the first ordering method in the model (3), it is also possible to provide a remote controller for operating a household electrical appliance such as a television with the function of the writing device 36 and writing information such as image specifying information into a scene marker when the user performs an operation of designating an image as an object of the print order with keys or the like of the remote controller.

Model (4): Images of Fixed-Point Commemorative Photograph in Sightseeing Spot

A fixed-point unmanned camera (DSC) is disposed in a place, which is often chosen as a place having a background suitable for a commemorative photograph in a sightseeing spot or the like. The user who visits the sightseeing spot or the like without bringing a camera and takes a commemorative photograph by using the fixed-point unmanned camera (by the user himself/herself). Although a self shutter function of the fixed-point unmanned camera may be used, a scene marker or the like may be allowed to function as a remote controller of the fixed-point unmanned camera.

There are some methods of making an order of printing an image of a fixed-point commemorative photograph taken by the fixed-point unmanned camera. According to a first method, an image of a fixed-point commemorative photograph is displayed on a display component (for example, a display of an electronic signboard) built in or attached to the fixed-point unmanned camera, and the user makes an order of printing the image of the fixed-point commemorative photograph by either the first or second ordering method.

According to the second method, the function of the writing device 36 is provided in the fixed-point unmanned camera. When a picture is taken according to an instruction of the user, the fixed-point unmanned camera writes code information (which can be constructed by, for example, information such as identification information of the fixed-point unmanned camera, frame number, and position and time of taking a picture) for identifying an image of a fixed-point commemorative photograph photographed into the scene marker of the user (thumbnail image data can be also written). According to the method, an order of printing can be made by the first ordering method.

A third method is a method, which can be applied when a storage capacity of the scene marker is large and writes image data (high-quality image data or data obtained by compressing high-quality image data) in place of the code information in the second method. According to the method as well, an order of printing can be made by the first ordering method (however, it is unnecessary to transfer high-quality image data from the content provider).

A fourth method is a method in which images of fixed-point commemorative photographs are put on view on a computer network which can be easily accessed by the users (for example, showing the images on a web page of the owner of the fixed-point unmanned camera (content provider/distributor) on a specific web server of the Internet), and the user accesses the computer network via an information terminal such as a PC or portable telephone to see and check the images of the fixed-point commemorative photographs, and makes an order of printing a favorite image. In this method, a print order can be made by the second ordering method. In the case where a password or the like to view images is taught to the user at the time of taking photographs and the user enters the taught password or the like, thereby enabling the images to be viewed, even if the images of the fixed-point commemorative photographs are put on view on a computer network, privacy of the user can be guarded.

Model (5): Images in School of Children

Parents do not have plenty of opportunities to see the school life of their children. Consequently, a photographer in the town goes to the school and takes photographs at the time of athletic meeting, music concert, school excursion, regular classes, and so on or the photographer lends a cheap DSC to children so that the children can take pictures freely, thereby collecting images of the school life of children (images by which the parents can see daily school life of the children).

The images taken or collected in such a manner are displayed on an electronic signboard disposed by a print finishing operator or the photographer (content provider/distributor), put on view on a computer network which can be easily accessed by users, (for example, the images are displayed on a web page made by the print finishing operator or the photographer on a specific web server of the Internet), or viewed via a receiving machine, thereby enabling the images to be presented to the users (parents of the children and so on). A title of “athletic meeting of xxx elementary school” or the like and other characters may be superimposed on the images presented to the user. In this case, the user can make a printing order by the first or second ordering method.

Although the case where the scene marker has the payment function has been described above, the invention is not limited to the case. A print finishing operator may send a generated photographic print by cash-on-delivery or the user may make a payment when the user comes to the shop of the print finishing operator to pickup a photographic print. By using the payment function of the scene marker and completing the payment on line on placement of the print order, it is preferable since the photographic print can be promptly given without dealing with money.

Although the embodiment in which the user has the scene marker (or a recording medium on which user information is recorded) has been described above, the invention is not limited to the embodiment but also includes an embodiment in which the user does not have something like a scene marker. If the user has a scene marker or the like, there is an advantage that the identification of a receiving machine at the time of delivering the photographic print can be accurately authenticated. Also in the case such that the place where the user makes a print order and the place where the user receives the photographic print are apart from each other, the process of delivering the photographic print can be performed without making a mistake.

The image order processor 12 may provide various services (point service and provision of service information) to each of users in accordance with a usage state of the image distributing and order-processing system 10 of the user by using user information sent from the receiving machine or the like.

Although the example of providing the image DB only for the large photo lab (image order processor 12) has been described above, the invention is not limited to the example. Particularly, in an embodiment where the receiving machine 38 is connected to the MI network 16 via the computer 20 of the print finishing operator, it is also possible to provide the image DB also in the computer 20 of the print finishing operator and store images of strong local color (for example, images of school life of children described in the model (5) and images of a local festival).

In the first ordering method, when thumbnail image data is distributed from the content provider (or manager) to the image order processor 12, high-quality image data (preferably, decoded) may be simultaneously distributed. With the configuration, the number of communication times performed between the content provider and the image order processor 12 can be reduced.

Although the case where the user who makes a print order and the content provider are different from each other has been described above, the user making a print order can be also the content provider. The user can make an order of printing an image of image content provided by the user himself/herself (for example, an image photographed by the user).

For example, as presently performed in a portable telephone, the user pays a predetermined amount of money to borrow a DSC (prepaid DSC) capable of taking a predetermined number of images corresponding to the paid amount, returns the prepaid DSC by which a predetermined number of photographs are taken. A prepaid DSC dealer reads out image data recorded in the returned prepaid DSC and puts them on view as images on a computer network (for example, displaying images on a web page provided by the prepaid DSC dealer on a specific web server of the Internet) so that the images can be viewed via the receiving machine, thereby enabling the images to be presented to the user who borrowed the prepaid DSC. In this case, the user can make an order or printing the images photographed by himself/herself by the first or second ordering method.

The communication speed of a portable telephone is already determined to be increased. The communication speed of a portable telephone system of the next generation (fourth generation) of IMT2000 as a portable telephone system of the third generation will be tens Mbps (like that of an optical fiber) which is more than one thousand times as fast as that of an existing portable telephone system. Obviously, the system can easily function as a scene marker and transfer high-quality image data in short time. The number of pixels of a small CCD camera to be mounted on a portable telephone of the third generation is small and is not suitable for generation of a photographic print of high quality. However, a high-grade DSC having a large number of pixels is connected to a portable telephone and high-quality image data obtained by the user with the DSC is transferred to the image order processor 12 via the portable telephone, thereby enabling a print order to be made. By loading a recording medium on which high-quality image data is recorded by photographing images with a DSC into a portable telephone in place of connecting the DSC to the portable telephone and transferring image data, the high-quality image data can be transferred.

What is claimed is:

1. An order information writing device attached to a display component for displaying image content, the order information writing device comprising:
an obtaining component for obtaining, when a user designates an image included among image content displayed on the display component as an image to be printed, information for specifying the image to be printed; and
a writing component for writing the information obtained by the obtaining component into the storing component that stores information and is disposed in a portable device which is held by the user and includes at least the storing component.

2. The order information writing device of claim 1, wherein the obtaining component obtains the information for specifying the image to be printed from a display control component for controlling displaying of image content onto the display component.

3. The order information writing device of claim 1, wherein the obtaining component obtains thumbnail image data corresponding to the designated image, and the writing component also writes the thumbnail image data obtained by the obtaining component.

4. An order receiving apparatus comprising:
a reading component including at least a storing component for storing information, the reading component for reading information, which specifies an image to be printed, from a storing component of a portable device when a user having the portable device, into the storing component of which the information for specifying the image to be printed is written by an order information writing device, expresses an intention to make a printing order; and
a first receiving component for receiving the printing order by transmitting the information for specifying the image to be printed, which information is read out by the reading component, to an image order processor connected via a communication line, for receiving the printing order from the user and performing a predetermined process,
wherein the order information writing device is attached to a display component for displaying image content, the order information writing device comprises:
an obtaining component for obtaining, when the user designates an image included among image content displayed on the display component as an image to be printed, information for specifying the image to be printed; and
a writing component for writing the information obtained by the obtaining component into the storing component that stores information and is disposed in a portable device held by the user and includes the at least the storing component.

5. The order receiving apparatus of claim 4, wherein the first receiving component performs at least one of an operation of reading information for specifying the user, which information is written in the storing component of the portable device in advance, and transmitting the information to the image order processor and an operation of writing information for identifying the received order of printing into the storing component of the portable device.

6. The order receiving apparatus of claim 4, further comprising a confirming component for re-confirming an expressed intention of making printing order for the image whose thumbnail image is displayed on the display component when the user expresses the intention of making the printing order, by displaying a thumbnail image of the image to be printed on a display component for displaying any information.

7. The order receiving apparatus of claim 6, wherein the obtaining component of the order information writing device also obtains thumbnail image data of the designated image,
the writing component of the order information writing device also writes the thumbnail image data obtained by the obtaining component, and
the thumbnail image data written by the writing component is stored in the storing component of the portable device, and the confirming component makes the thumbnail image of the image to be printed to be displayed on the display component using the thumbnail image data read from the storing component of the portable device by the reading component.

8. The order receiving apparatus of claim 4, wherein details of the order of printing are designated by the user, and the first or second receiving component transmits information indicating the designated details of the order of printing to the image order processor.

9. The order receiving apparatus of claim 8, wherein the content of the order of printing designated by the user includes at least one of a number of prints, a print size, a kind of recording material for recording the image, and a designation of at least one of a processing and a synthesis of the image to be printed.

10. The order receiving apparatus of claim 4, wherein the predetermined process performed by the image order processor includes a process of calculating a fee for the order of printing made by the user and gives notification of the fee, and
the first receiving component allows the notification of the fee from the image order processor to be displayed on the display component capable of displaying any information.

11. The order receiving apparatus of claim 4, further comprising
a payment process component for performing a process for making a payment for the order of printing in co-operation with a payment information holding component which is mounted on the portable device held by the user, for holding information for making the payment for the order of printing made by the user.

12. The order receiving apparatus of claim 4, further comprising
an input component for inputting information desired by the user,
wherein at least one of the expression of the intention by the user to make the order of printing, the designation of the image to be printed, the instruction of the details of the order of printing, and input of information for making a payment for the order of printing, is performed via the input component.

13. An order receiving apparatus attached to a display component for displaying image content, the order receiving apparatus comprising:
an obtaining component, for obtaining information specifying an image which is to be printed when a user designates an image included among image content displayed on the display component as the image to be printed; and
a second receiving component for receiving a printing order by transmitting the obtained information specifying the image to be printed to an image order processor, which is connected via a communication line receives the order of printing from the user, and performs a predetermined process performing at least one of an operation of reading information specifying the user written in a storing component of a portable device in advance, which portable device is held by the user and is provided with at least the storing component capable of storing information, and transmitting the read information to the image order processor, and an operation of writing information identifying the received printing order into the storing component of the portable device.

14. The order receiving apparatus of claim 13, wherein the obtaining component obtains the information specifying the image to be printed from a display control component for controlling a display of image content onto the display component.

15. The order receiving apparatus of claim 13, wherein the details of the order of printing are designated by the user, and the first or second receiving component transmits information indicating the designated details of the order of printing to the image order processor.

16. The order receiving apparatus of claim 15, wherein the details of the order of printing designated by the user includes at least one of a number of prints, a print size, a kind of recording material for recording the image, and a designation of at least one of a processing and a synthesis of the image to be printed.

17. The order receiving apparatus of claim 13, wherein the predetermined process performed by the image order processor includes a process of calculating a fee for the order of printing made by the user and gives notification of the fee, and
the first or second receiving component allows the notification of the fee from the image order processor to be displayed on the display component for displaying any information.

18. The order receiving apparatus of claim 13, further comprising
a payment process component for performing a process for making a payment for the order of printing in co-operation with a payment information holding component which is mounted on the portable device held by the user, for holding information for making the payment for the order of printing made by the user.

19. The order receiving apparatus of claim 13, further comprising
an input component for inputting information desired by the user,
wherein at least one of the expression of the intention by the user to make the order of printing, the designation of the image to be printed, the instruction of the details of the order of printing, and input of information for making a payment for the order of printing, is performed via the input component.

20. A portable device for operation by a user and including at least a storing component for storing information, the portable device comprising:
a storing component for having information specifying an image to be printed written by a writing component of an order information writing device when the user designates, to the order information writing device, the image included among image content displayed on a display component as the image to be printed and, for having the information specifying the image to be printed be read out therefrom by a reading component of an order receiving apparatus when the user expresses, to the order receiving apparatus, an intention to make the order of printing,
wherein the order information writing device is attached to the display component for displaying the image content, and the order information writing device includes
an obtaining component for obtaining, when the user designates an image included among image content displayed on the display component as an image to be printed, information for specifying the image to be printed; and
a writing component for writing the information obtained by the obtaining component into the storing component that stores information and is disposed in the portable device which is held by the user and includes at least the storing component, and the order receiving apparatus includes
a reading component including at least a storing component for storing information, the reading component for reading information, which specifies an image to be printed, from a storing component of a portable device when the user having the portable device, into the storing component of which the information for specifying the image to be printed is written by an order information writing device, expresses an intention to make a printing order; and
a first receiving component for receiving the printing order by transmitting the information for specifying the image to be printed, which information is read out by the reading component, to the image order processor for receiving the printing order from the user and performing a predetermined process, the image order processor being connected via a communication line.

21. The portable device of claim 20, wherein the user expresses an intention to make a printing order, thereby performing, with the first receiving component of the order receiving apparatus, at least one of reading information for specifying the user written in the storing component in advance and writing the information for identifying the order of printing, which was received by the first receiving component, into the storing component.

22. The portable device of claim 20, further comprising
a payment information holding component for holding information to make a payment for the order of printing made by the user and performing a process of making the payment for the order of printing in co-operation with the payment process component,
wherein the payment process component is disposed in the order receiving apparatus.

23. A portable device for operation by a user and including at least a storing component for storing information the portable device comprising:
the storing component for having information specifying an image to be printed written by a writing component of an order information writing device when the user designates, to the order information writing device, the image included among image content displayed on a display component as the image to be printed and, for having the information specifying the image to be printed be read out therefrom by a reading component of an order receiving apparatus when the user expresses, to the order receiving apparatus, an intention to make the order of printing,
wherein the order information writing device is attached to the display component for displaying the image content, and the order information writing device includes
an obtaining component for obtaining, when a user designates an image included among image content displayed on the display component as an image to be printed, information for specifying the image to be printed; and
a writing component for writing the information obtained by the obtaining component into the storing component that stores information and is disposed in the portable device which is held by the user and includes at least the storing component, and
the order receiving apparatus is attached to the display component for displaying image content and includes
an obtaining component for obtaining information specifying an image to be printed when the user designates an image included among image content displayed on the display component as the image to be printed; and
a second receiving component for receiving the order of printing by transmitting, to the image order processor which receives the order of printing from the user and performs a predetermined process and is connected via a communication line, the information specifying the image to be printed, and performing at least one of an operation of reading the information specifying the user written in the storing component of the portable device held by the user in advance and provided with at least the storing component capable of storing information and transmitting the read information to the image order processor, and an operation of writing the information for identifying the received printing order into the storing component of the portable device.

24. The portable device of claim 23, wherein when the user expresses the intention to make the order of printing, at least one of reading the information for specifying the user written in the storing component in advance and writing the information for identifying the order of printing received by the first receiving component into the storing component is performed by the first receiving component of the order receiving apparatus.

25. The portable device of claim 23, further comprising:
a payment information holding component for holding information for making a payment for the order of printing made by the user and performing a process of making a payment for the order of printing in co-operation with the payment process component
wherein the payment process component is included in the order receiving apparatus.

26. A portable device held by a user and including at least a storing component capable of storing information, characterized by
performing, when the user designates an image included among image content displayed on a display component as an image to be printed to the order receiving apparatus and expresses an intention to make an order of printing, at least one of an operation of storing information specifying the user and reading the information specifying the user which is written in the storing component in advance, with a second receiving component of an order receiving apparatus and an operation of writing the information for identifying the order of printing received by the second receiving component, into the storing component,
wherein the order receiving apparatus is attached to the display component for displaying image content, and includes
an obtaining component for obtaining information specifying the image to be printed, when the user designates the image included among the image content displayed on the display component as the image to be printed; and
a second receiving component for receiving the order of printing by transmitting the information specifying the image to be printed obtained by the obtaining component to an image order processor for receiving the printing order from the user, which is connected via a communication line, and performing at least one of an operation of reading the information for specifying the user written in a storing component of the portable device held by the user in advance and provided with at least the storing component capable of storing information and transmitting the read information to the image order processor, and an operation of writing the information identifying the received order of printing into the storing component of the portable device.

27. The portable device of claim 26, further comprising
a payment information holding component for holding information for making a payment for the order of printing made by the user and performing a process of making a payment for the order of printing in co-operation with a payment process component,
wherein the payment process component is included in the order receiving apparatus.

28. A print order receiving method comprising the steps of:
obtaining information for specifying an image to be printed when a user designates an image included among image content displayed on a display component as an image to be printed;
writing the obtained information into a storing component of a portable device, which is held by the user and provided with at least the storing component capable of storing information;
reading the information for specifying the image to be printed when the user expresses intention to make an order of printing, which information is written in the storing component of the portable device held by the user; and
receiving the order of printing by transmitting the read information for specifying the image to be printed to an image order processor for receiving the order of printing from the user and performing a predetermined process.

29. A print order receiving method comprising the steps of:
obtaining information for specifying an image to be printed when an image included among image content displayed on a display component is designated by the user, as an image to be printed;
receiving the order of printing by transmitting the information for specifying the obtained image to be printed to an image order processor which receives the order of printing from the user and performs a predetermined process; and
performing at least one reading of the information for specifying the user written, in advance, in a storing component of a portable device held by the user and provided with at least the storing component capable of storing information and writing of the received information for identifying the received order of printing.
